(19) United States
(12) Patent Application Publication
(10) Pub. No.: US 2021/0174415 A1
(43) Pub. Date: Jun. 10, 2021

(54) METHODS AND SYSTEMS FOR PERFORMING AN ADVERTISEMENT BASED SINGLE STEP ELECTRONIC TRANSACTION WITH OR WITHOUT USING A CUSTOM APPLICATION

(71) Applicant: Omnyway Inc., San Mateo, CA (US)

(72) Inventors: Ashok Narasimhan, San Francisco, CA (US); Mohammad Khan, San Jose, CA (US); Satyanarayana Udipi Mallya, San Jose, CA (US); Laura Ann Torbett Giddings, Los Gatos, CA (US); Robert Jay Berger, Saratoga, CA (US); Sriram Krishnan, San Jose, CA (US)

(21) Appl. No.: 17/268,447

(22) PCT Filed: Aug. 16, 2019
(86) PCT No.: PCT/US19/46916

§ 371 Date: Feb. 12, 2021

Related U.S. Application Data
(60) Provisional application No. 62/764,830, filed on Aug. 16, 2018.

(51) Int. Cl. G06Q 30/06; G06Q 30/02; G06Q 20/40; G06Q 20/38; H04L 29/06; H04L 29/08

(52) U.S. Cl. CPC G06Q 30/0609; H04L 67/146; G06Q 30/0277; G06Q 20/4016; G06Q 20/3825; G06Q 30/0255; G06Q 30/0269; G06Q 20/385; G06Q 20/4018; G06Q 30/0633; G06Q 30/0611; G06Q 30/0248; G06Q 30/0244; H04L 63/0876; G06Q 30/0641

(57) ABSTRACT

Methods and systems for performing an advertisement based single step electronic transaction with or without using a custom application are provided. According to one aspect, a method for performing an advertisement based single step electronic transaction comprises, at a backend server: receiving an indication that a user is interested in a product in an advertisement that was presented to the user; generating transaction information, the transaction information including product information, payment instrument information, and shipping information, and presenting it to the user in a manner such that the user need only perform a single step in order to trigger the transaction; detecting that the user has performed the single step; initiating the transaction; and notifying the user of the result of the transaction.

### RELATED APPLICATIONS

This application is a U.S. National Stage application under 35 USC 371 of International Application No. PCT/US2019/046916 filed Aug. 16, 2019, which claims the benefit of U.S. Provisional Patent Application No. 62/764,830, filed Aug. 16, 2018, both of which are hereby incorporated herein by reference in their entirety.

### TECHNICAL FIELD

This disclosure relates to performing secure financial and non-financial electronic transactions made by consumers seamlessly with minimum number of steps, thus driving high conversion rate and providing better Returns On Ad Spending (ROAS) to sellers. More specifically, it relates to methods and systems for performing an advertisement-based single-step electronic transaction with or without using a custom application.

### BACKGROUND

Merchants desire the ability to tempt consumers with goods and services and the like in a manner that makes it very easy for the consumer to make a purchase instantly, e.g., with few, if any, barriers to making the transaction. In an era in which electronic devices give instant access to a wide variety of content, consumers are less likely to tolerate any delay or obstacle to a purchase. Thus, there is a desire to provide a consumer with the ability to make a purchase with minimal action on the consumer's part, referred to herein as a “frictionless” transaction.

Merchants also desire the ability to target advertisements to particular consumers, not only to loyal customers who are likely to engage in repeat business but also to potential new customers. Merchants also desire the ability to provide advertisements wherever an existing or potential customer may come in contact with an advertisement, whether it be a physical advertisement in a magazine, billboard, or other public or private places, a virtual advertisement on a webpage within an application, embedded within streaming content, delivered to a user's electronic device, automobile, home appliance, or other platform.

Methods and systems by which targeted or non-targeted ads could be presented or made available to potential consumers in a manner that allows a frictionless transaction are therefore highly desirable to merchants, where merchants could be physical store and/or online merchants, manufacturers, brands, service providers, distributors or any type of sellers.

Most merchants make use of advertisement channels, e.g., they pay a fee to another business entity that has the infrastructure to place or position advertisements in locations where potential customers are likely to see them, such as on social media pages. The most fee structures are called CPM (Cost Per Thousand) and CPC (Cost Per Click). In the CPM fee structure, the merchant pays every time an advertisement is displayed, regardless of whether that advertisement is ever clicked by a viewer. In the CPC fee structure, the merchant pays every time an advertisement is clicked, regardless of whether that click results in a sale of the advertised item.

### SUMMARY

According to one aspect of the present disclosure, a method for performing an enriched advertisement-based single-step electronic transaction with or without using a custom application comprises, at a backend server: receiving an indication that a user is interested in a product in an advertisement that was presented to the user; generating transaction information, the transaction information including product information, payment instrument information, and shipping information, and presenting it to the user in a manner such that the user need only perform a single step in order to trigger the transaction; detecting that the user has performed the single step; initiating the transaction; and notifying the user of the result of the transaction.

In some embodiments, initiating the transaction comprises sending the transaction and payment information directly or indirectly to relevant parties for payment processing and fulfilment of the ecommerce transaction.

In some embodiments, presenting the transaction information to the user comprises generating and presenting to the user a landing page that includes the transaction information along with a button or image which the user can click or touch to initiate the transaction.

In some embodiments, the method further comprises, prior to generating the transaction information: determining that the user is a returning, untrusted user; in response to determining that the user is a returning, untrusted user, requesting the user to authenticate with the payment provider; and receiving an indication of the result.

In some embodiments, determining that the user is a returning, untrusted user comprises determining that the user identity is known but the user device is not associated with the user or determining that the user has engaged in potentially fraudulent activity.

In some embodiments, receiving an indication of the result comprises receiving an indication that the authentication was successful and wherein the backend server associates the device with the user.

In some embodiments, receiving an indication of the result comprises receiving an indication that the authentication was unsuccessful and wherein the backend server marks the user device as being compromised.

In some embodiments, the method further comprises, prior to generating transaction information: determining that the user is a new user; in response to determining that the user is a new user: requesting the user to sign in with a payment provider and accept a checking/billing agreement that allows the backend server and/or seller to make payments on behalf of the user via the user's payment provider account; storing customer information for the user; generating cookie or other tracking information; and storing an association of the cookie and a device signature of the device used by the user.

In some embodiments, the method further comprises providing the cookie and/or java script to the landing page.

In some embodiments, the advertisement that was presented to the user was presented by an Advertising Partner that: detected an association between the user and a payment provider; matched the user to an advertising campaign segment; filtered the user based on past user behavior; filtered the user based on a fraud score and/or user history of behaviors; matched the product based on user interest history; retrieved the ad creative that includes a backend server URL; and placed the targeted ad into content being consumed by the user.

In some embodiments, initiating the purchase comprises: executing fraud business rules locally or at an entity different from the backend server; determining a fraud score based on behavior, history, velocity, and/or device signature; upon a determination that fraud is likely, declining the purchase; and upon a determination that fraud is not likely, initiating a transaction with the payment provider.

In some embodiments, initiating the transaction with the payment provider comprises: retrieving payment information from the payment provider; placing the order; reporting the order status to the user; and displaying a receipt to the user.

In some embodiments, retrieving payment information from the payment provider comprises: requesting a Tokenized Primary Account Number (TPAN) from the payment provider, the request identifying the checkout/billing agreement and a transaction total; and receiving the TPAN representing the card account number, CVV/CVC, and expiration date, which are used when placing the order.

In some embodiments, initiating the transaction with the payment provider comprises: providing transaction information to a payment provider to process payment transaction; receiving transaction result information from the payment provider.

In some embodiments, providing transaction information comprises providing an amount, a customer ID, and/or a seller ID.

In some embodiments, receiving transaction result information comprises receiving a transaction ID, an authorization ID, a transaction amount, and/or a retailer ID.

In some embodiments, the method further comprises, at the backend server: detecting an update trigger event; in response to detecting the update trigger event, performing at least one of: requesting a list of products from a retailer backend and updating product and pricing information maintained by the backend server; requesting a list of offers from the retailer backend and updating offer information maintained by the backend server; and requesting a list of available inventory form the retailer backend and updating inventory information maintained by the backend server.

In some embodiments, detecting an update trigger event comprises detecting creation of a new ad campaign, and/or detecting a change in products, offers, or inventory status.

In some embodiments, the method further comprises requesting a payment provider to provide a list of user IDs for ad targeting; and registering or push notification from the payment provider.

In some embodiments, the method further comprises, during an ad campaign wherein an advertising partner is serving ads through ad servers, receiving feedback or detecting changing conditions, and in response: requesting product inventory update; targeting updates based on behavior, fraud or other condition or trend; receiving verification that ads are being served to targeted users/devices; and/or sending ad offers and creative updates to the ad partner.

In some embodiments, the method further comprises receiving, from a campaign manager, a request to get products from a catalogue, retrieving current inventory from a retailer backend, and applying inventory rules for algorithms; receiving ad offers and applying algorithms for the ad offers; receiving a request to run algorithms for targets for ad offers, collecting target metrics from the retailer backend, and applying algorithms for ad offers; sending targets in segment for review by the campaign manager; and/or receiving ad creatives and dynamically creating ads and associated backend server URL links.

According to another aspect of the present disclosure, a system for performing an enriched advertisement-based single-step electronic transaction with or without a custom application comprises a backend server, the backend server comprising: one or more processors, and memory storing instructions executable by the one or more processors, whereby the backend server is operable to: receive an indication that a user is interested in a product in an advertisement that was presented to the user; generate transaction information, the transaction information including product information, payment instrument information, and shipping information, and present it to the user in a manner such that the user need only perform a single step in order to trigger the transaction; detect that the user has performed the single step; initiate the transaction; and notify the user of the result of the transaction.

In some embodiments, the backend server is further operable to perform any of the steps of any of the backend server methods described herein.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIGS. 1A-1C illustrate a process for performing an advertisement based single step electronic transaction according to some embodiments of the present disclosure;

FIGS. 2A-2F illustrate a process for performing an advertisement based single step electronic transaction according to other embodiments of the present disclosure;

FIGS. 3A-3E illustrate a process for performing an advertisement based single step electronic transaction according to other embodiments of the present disclosure;

FIGS. 4A-4E illustrate a process for performing an advertisement based single step electronic transaction according to other embodiments of the present disclosure;

FIG. 5 is a signaling diagram illustrating an exemplary process for providing a targeted advertisement (“ad”) to a user according to some embodiments of the present disclosure, describing some of the events that occur when the user clicks on the targeted ad;

FIG. 6 is a signaling diagram illustrating an exemplary process for providing a targeted ad to a user according to some embodiments of the present disclosure, describing some of the events that occur for a new user;

FIG. 7 is a signaling diagram illustrating an exemplary process for providing a targeted ad to a user according to some embodiments of the present disclosure, describing some of the events that occur for a returning user;

FIG. 8 is a signaling diagram illustrating an exemplary process for providing a targeted ad to a user according to some embodiments of the present disclosure, describing some of the steps that occur during a request for user authentication;

FIG. 9 is a signaling diagram illustrating an exemplary process for providing a targeted ad to a user according to some embodiments of the present disclosure, describing some of the steps that occur when the user clicks on the “buy now” button;

FIG. 10 is a signaling diagram illustrating an exemplary process for providing a targeted ad to a user according to other embodiments of the present disclosure, describing some of the steps that occur when the user clicks on the “buy now” button;

FIGS. 11A and 11B are flowcharts illustrating example flows in flowchart form rather than in as signaling diagrams according to some embodiments of the present disclosure;

FIGS. 12A and 12B include screen shots showing a close-up of an example Zapbuy™ product description page and checkout according to some embodiments of the present disclosure;

FIGS. 13A and 13B include screen shots showing a close-up of an example Zapbuy product description page and login with PayPal™ according to some embodiments of the present disclosure;

FIG. 14 includes a screen shot showing a close-up of an example Zapbuy receipt according to some embodiments of the present disclosure;

FIG. 15 is a block diagram showing an exemplary Omnyway Backend according to some embodiments of the present disclosure;

FIG. 16 is a block diagram showing an exemplary user device according to some embodiments of the present disclosure;

FIG. 17 is a signaling diagram illustrating an exemplary process for providing a targeted ad to a user according to some embodiments of the present disclosure, showing a portion of a process for setting up the Zapbuy backend;

FIG. 18 is a signaling diagram illustrating an exemplary process for providing a targeted ad to a user according to some embodiments of the present disclosure, showing another portion of a process for setting up the Zapbuy backend;

FIG. 19 is a signaling diagram illustrating an exemplary process for providing a targeted ad to a user according to some embodiments of the present disclosure, showing steps that may be performed to set up a Zapbuy campaign;

FIG. 20 is a signaling diagram illustrating an exemplary process for providing a targeted ad to a user according to some embodiments of the present disclosure, showing steps that may be performed to during operation of a Zapbuy campaign;

FIG. 21 provides an overview of an exemplary system for providing a targeted ad to a user according to some embodiments of the present disclosure;

FIG. 22 illustrates another aspect of the present disclosure, showing communication paths between a backend server and various entities;

FIG. 23 illustrates yet another aspect of the present disclosure, showing other communication paths between the backend server and various entities; and

FIG. 24 illustrates yet another aspect of the present disclosure, showing some relationships between the backend server and various entities.

### DETAILED DESCRIPTION

The subject matter disclosed herein comprises methods and systems for performing an advertisement-based, frictionless, electronic transaction, and more specifically to methods and systems for performing an advertisement-based single-step electronic transaction with or without using a custom application. Various embodiments will now be disclosed. These embodiments are illustrative and not limiting. In some embodiments, the methods and systems disclosed herein are referred to as “Zapbuy” methods and systems, respectively. An advertisement may also be referred to herein as “an ad”, and an application may also be referred to herein as “an app”, and can be presented to potential customers already enabled with a digital payment capability from brands like PayPal, Venmo™, Visa™, Mastercard™, American Express™, Discover, WeChat Pay™, Alipay™, Apple Pay™, Samsung Pay™, Google Pay™, or others. Such digital payment capability could be further enabled by payments brands for a quick payment experience like PayPal One Touch—where customer gets authenticated through multi-factor authentication schemes, and may not require customers to specifically enter user name and password. The techniques disclosed herein enable a fee structure called Cost Per Sale, or “CPS”. In this fee structure, a merchant does not pay a fee for each time an advertisement is displayed, or for each time an advertisement is clicked, but only for each time there is a sale of the product being advertised. This CPS model is more attractive to merchants than conventional CPM or CPC fee structures.

The following pages describe a number of example scenarios according to the subject matter disclosed herein, and how the methods and systems disclosed herein provide highly targeted, frictionless transactions, which merchants desire. In the examples below, a user sees an ad on the screen of a mobile device, but the subject matter is not limited to just this embodiment. A user could see or hear an ad through consumers' devices (e.g., mobile phone, tablet, mobile pc, desktop, wearable/watch, TV), through home smart devices (e.g., Alexa, Google Home), via appliances with screens (e.g., a refrigerator), via in-vehicle smart panels, via digital signages in a shop, shopping strip, or mall, and via in-store shelf smart devices. These examples are illustrative and not limiting.

The concepts and principles described herein may be implemented in various ways. As will be explained below, the methods described herein may be implemented within or interacting with a custom application, such as within a banking app, a service provider app, or a merchant app, for example, but they may also be implemented without requiring a custom application, e.g., the method may be implemented using a standard or generic web browser. From the user's perspective, in some embodiments the user clicks on an advertisement, which causes the transaction information to be displayed to the user in whichever application was displaying the advertisement. The user can initiate the transaction in a “single step”, e.g., by performing one action, such as clicking a “place order” button, and after the transaction is completed, the user is returned to the original context (e.g., back to the web page/custom app page/etc., that displayed the ad which the user clicked on) automatically.

### Example 1—Returning Zapbuy Shopper

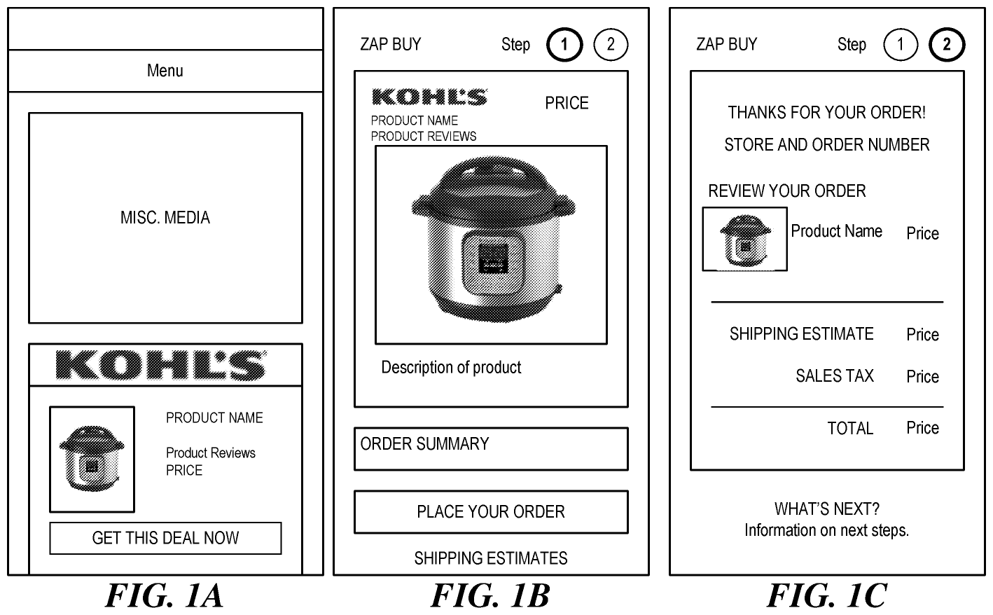

FIGS. 1A-1C illustrate a process for performing an advertisement based single step electronic transaction according to some embodiments of the present disclosure. In this example, the shopper has One Touch and has previously signed the Billing Agreement.

The shopper consumes some media and is targeted with mobile Zapbuy advertisement for a product (in this example, an Instant Pot™) from a store (in this example, Kohl's) with a special Zapbuy price (FIG. 1A).

The shopper clicks on the Zapbuy advertisement and arrives on the Zapbuy landing page, which may also be referred to herein as a “Buy Now” page (FIG. 1B). The landing page looks for the Zapbuy cookie and sends it to the Zapbuy service. The cookie and other security parameters are checked and, in this scenario, the shopper is sufficiently identified. The returning shopper is taken directly to the product details page (PDP). The PDP shows product information, the total price with tax and shipping, the shipping address and PayPal account (email) to be used for the payment.

The shopper presses the Place Order button to complete the transaction at Kohl's for the Instant Pot product and is presented the Zapbuy receipt (FIG. 1C). Kohl's will email and fulfill the order with the customer just as any other e-commerce transaction.

It is noted that in this and other examples described herein, the advertisement may be displayed within a custom application, such as, but not limited to, a banking app, a merchant app, etc., and clicking on the advertisement causes the landing page to be displayed by the custom application. Likewise, the advertisement may be displayed within a generic web browser or other standard, non-custom/non-customer-specific application, and clicking on the advertisement causes the landing page to be generated by a backend server and displayed by the same application, e.g., by the web browser, without requiring or engaging a customer application. By the same principle, in other embodiments, clicking on an ad in a browser may cause a custom app to open (if not open already) and display the landing page, and clicking on an ad in a custom app may cause a browser to open (if not open already) and display the landing page. The same principles described above with regard to the landing page also apply to any other information displayed to the user during the process, such as the product details page, the transaction result or receipt page, and so on.

### Example 2—New Zapbuy Shopper, New PayPal One Touch User

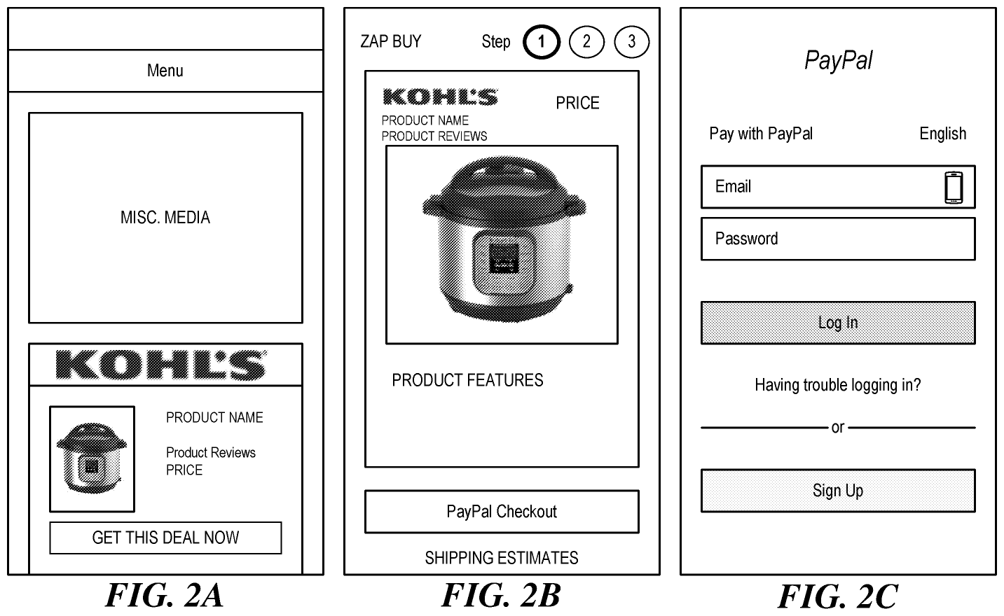

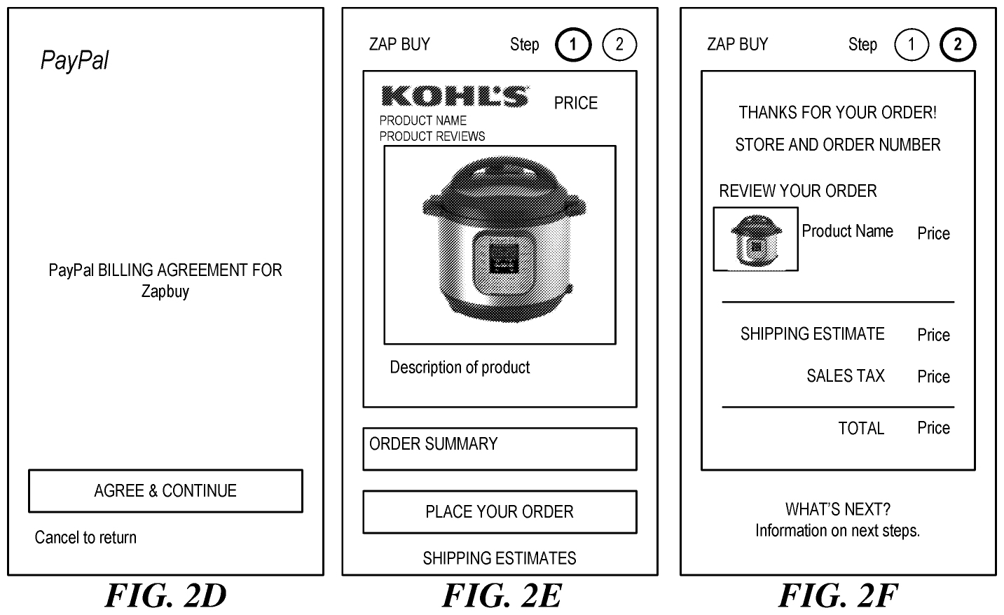

FIGS. 2A-2F illustrate a process for performing an advertisement based single step electronic transaction according to other embodiments of the present disclosure. This example involves a new Zapbuy shopper who is either a new PayPal user or an existing PayPal user without One Touch enabled and without a prior Billing Agreement.

The shopper consumes some media and is targeted with mobile Zapbuy advertisement for the Instant Pot from Kohl's with a special Zapbuy price (FIG. 2A).

The shopper clicks on the Zapbuy advertisement and arrives on the Zapbuy landing page (FIG. 2B). The landing page looks for the Zapbuy cookie and if found sends it to the Zapbuy service. Since the cookie is absent in this scenario, the shopper is presented with a product page without the shopper information and prompted to “PayPal Checkout”. The page shows the customer the product, retailer and PayPal brands.

If the shopper does not have One Touch enabled, then she is shown a PayPal login screen (FIG. 2C). From here the user can sign up to be new PayPal user or can log in as an existing PayPal user.

After logging in successfully (or getting logged in with One Touch), the shopper is presented with a PayPal Billing Agreement for Zapbuy (FIG. 2D).

Now the shopper is taken to the product details page (FIG. 2E) and can now use Zapbuy for this and subsequent purchases. The billing agreement authorizes access to the shopper's shipping address and payment instrument, which may be provided by the payment instrument provider. The billing agreement may have also been received as a consent from a shopper digitally or in writing in past. The product details page (PDP), shows the total price with tax and shipping, the shipping address and payment instrument to be used.

The shopper presses the Place Order button to complete the transaction at Kohl's for the Instant Pot product and is presented the Zapbuy receipt (FIG. 2F). Kohl's will email and fulfill the order with the customer just as any other e-commerce transaction.

It should be noted that, in the example in FIG. 2E and in other examples, only a portion of the screen may be shown, e.g., other information not visible in the example screen may be available to the user by scrolling or swiping the display.

### Example 3—New Zapbuy Shopper, Existing PayPal One Touch User

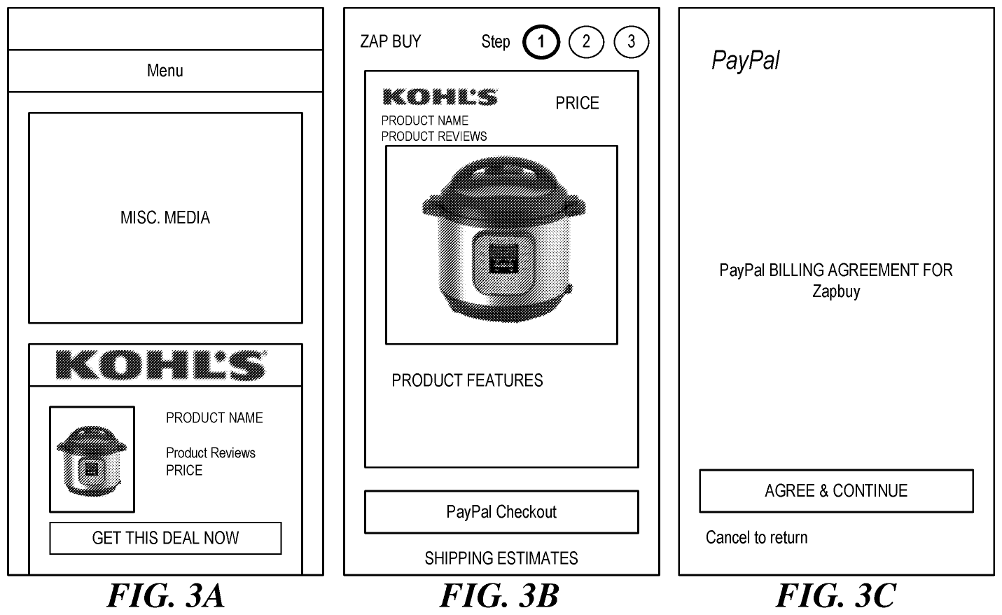

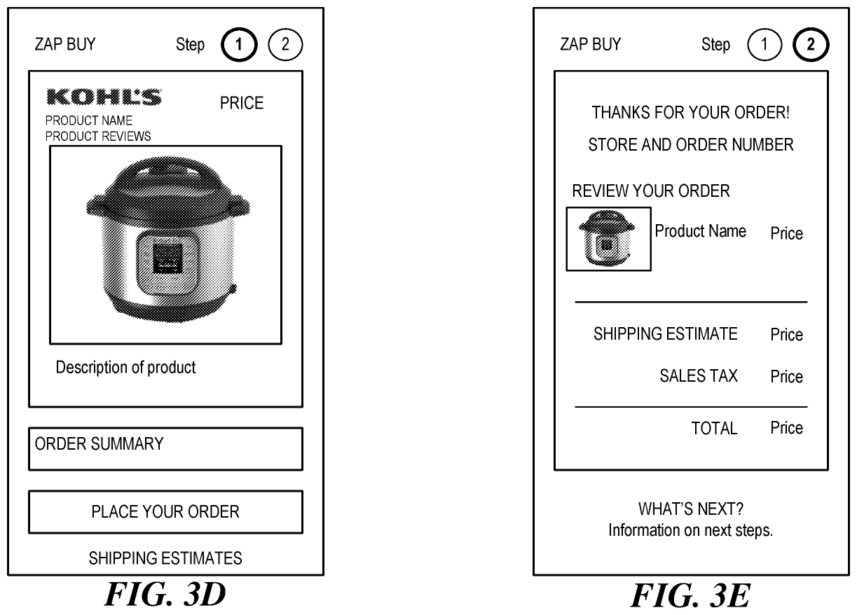

FIGS. 3A-3E illustrate a process for performing an advertisement based single step electronic transaction according to other embodiments of the present disclosure. This example involves a new Zapbuy shopper who is an existing PayPal customer with One Touch enabled but without a prior Billing Agreement. The shopper consumes some media and is targeted with mobile Zapbuy advertisement for the Instant Pot from Kohl's with a special Zapbuy price (FIG. 3A).

The shopper clicks on the Zapbuy advertisement and arrives on the Zapbuy landing page (FIG. 3B). The landing page looks for the Zapbuy cookie and if found sends it to the Zapbuy service. Since the cookie is absent in this scenario, the shopper is presented with a product page without the shopper information and prompted to “Check out with PayPal”. The page shows the customer the product, retailer and PayPal brands.

The shopper does have One Touch enabled, but is a first time Zapbuy user and so is presented with a PayPal Billing Agreement for Zapbuy (FIG. 3C).

Now the shopper is taken to the product details (FIG. 3D) and can now use Zapbuy for this and subsequent purchases. The billing agreement authorizes access to the shopper's shipping address and payment instrument, which may be provided by the payment instrument provider. The product details page (PDP), shows the total price with tax and shipping, the shipping address and payment instrument to be used.

The shopper presses the Place Order button to complete the transaction at Kohl's for the Instant Pot product and is presented the Zapbuy receipt (FIG. 3E). Kohl's will email and fulfill the order with the customer just as any other e-commerce transaction.

### Example 4—Returning Zapbuy User, High-Risk PayPal User

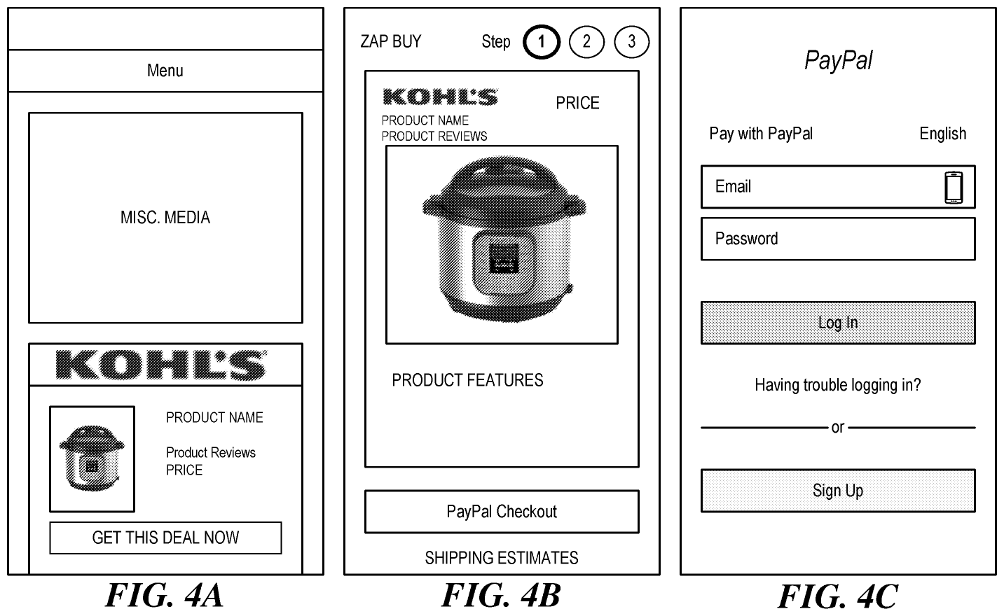

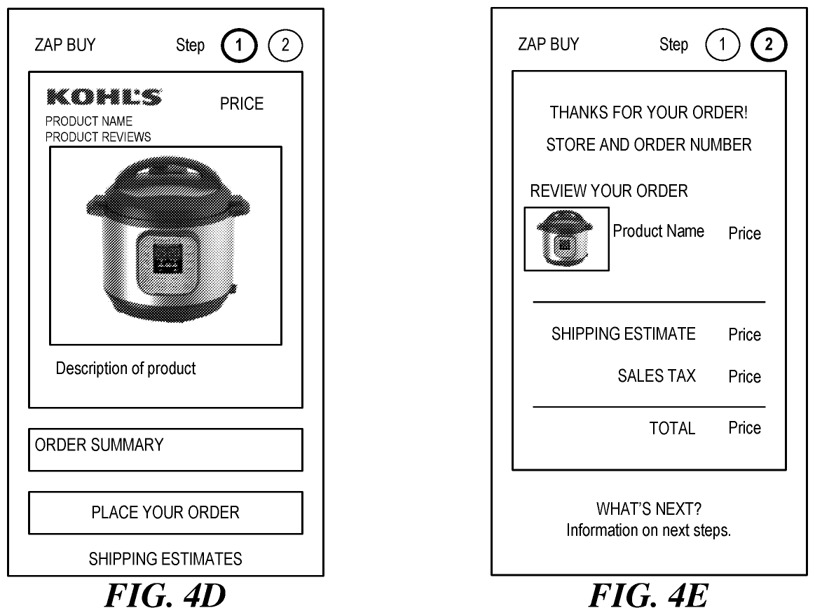

FIGS. 4A-4E illustrate a process for performing an advertisement based single step electronic transaction according to other embodiments of the present disclosure. This example involves a returning Zapbuy shopper who has been identified as a high-risk PayPal user. The shopper consumes some media and is targeted with mobile Zapbuy advertisement for the Instant Pot from Kohl's with a special Zapbuy price (FIG. 4A).

The shopper clicks on the Zapbuy advertisement and arrives on the Zapbuy landing page (FIG. 4B). The landing page looks for the Zapbuy cookie and if found sends it to the Zapbuy service. The cookie plus other security parameters are checked, and in this example the customer is flagged as high-risk, in which case PayPal One Touch is not allowed. The shopper is presented with the transitional screen and is asked to Continue to PayPal for validation, e.g., requesting login with PayPal.

The shopper is redirected to the PayPal login screen (FIG. 4C).

After logging in successfully and revalidating as a user, the existing billing agreement information is retrieved, and the shopper is taken to the product details page (FIG. 4D). The product details page (PDP), shows the total price with tax and shipping, the shipping address and payment instrument to be used.

The shopper presses the Place Order button to complete the transaction at Kohl's for the Instant Pot product and is presented the Zapbuy receipt (FIG. 4E). Kohl's will email and fulfill the order with the customer just as any other e-commerce transaction.

### Data Flows

Exemplary data flows will now be described for various aspects of the subject matter of the present disclosure. These data flows are illustrative and not intended to be limiting. The subject matter of the present disclosure is not limited to the particular embodiments described herein. The exemplary data flows may be described using flowcharts and/or using signaling diagrams, which may also be referred to as ladder diagrams, which describe the messages communicated between entities within the network and also describe the steps that each entity may take internally in response to the messages or other event.

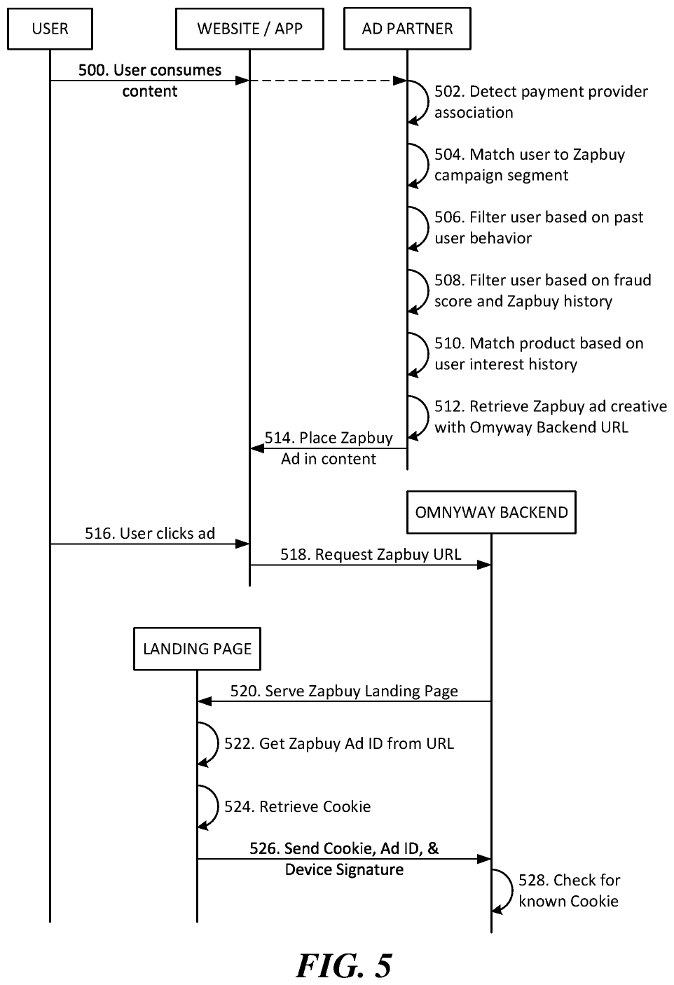

FIG. 5 is a signaling diagram illustrating an exemplary process for providing a targeted advertisement (“ad”) to a user according to some embodiments of the present disclosure, describing some of the events that occur when the user clicks on the targeted ad. In the embodiment illustrated in FIG. 5, a user is consuming content (step 500), e.g., the user is browsing a website, viewing content on a dedicated application (“app”), such as a social media app, streaming video content, playing an online game, etc. The ad being provided may also be referred to herein as an “enriched” ad, since, in some embodiments, the ad has, contains, or is associated with, the URL address of the Backend Server to drive the One Step transaction.

In the embodiment illustrated in FIG. 5, an advertising partner (“Ad Partner”) or other service that provides advertisements to websites, apps, and the like, provides targeted ads. In the embodiment illustrated in FIG. 5, the Ad Partner detects an association between the user and a payment provider (step 502), and matches the user to a Zapbuy campaign segment (step 504). The Ad Partner may filter the user based on past user behavior (step 506) and it may filter the use based on fraud score and/or Zapbuy history (step 508). In the embodiment illustrated in FIG. 5, the Ad Partner determines which products to target to the user, e.g., by matching a product based on the user's interest history (step 510), and retrieves the Zapbuy ad creative with an Omnyway Backend URL, which may also be referred to as a Zapbuy URL (step 512). The Ad Partner then places the Zapbuy Ad into the content being displayed by the website or app (step 514).

In some embodiments, the ad is targeted to selected users based on a determination that the user is holder of one or more specific payment instruments, e.g., PayPal, Visa, Mastercard, Amex, Discover, Citi, Bank of America, Chase, Alipay, WeChat Pay, Venmo, etc. In some embodiments, a user is targeted because the user is or could be interested in purchasing one or more products and/or services types, and/or has previously purchased and/or opted-in for the Buy Now advertising service. In some embodiments, the Omnyway Backend may coordinate with a payment provider, which may identify who its cardholders are and to target advertisements to those cardholders. In some embodiments, the image of the card or payment provider logo may be displayed on the ad itself.

In the embodiment illustrated in FIG. 5, if the user clicks the targeted ad (step 516), the website or app will request the Zapbuy URL (step 518). The Omnyway Backend will generate and serve a Zapbuy landing page (step 520). In some embodiments, the landing page will be generated within the same website browser or app, rather than starting another program for displaying the landing page, but in alternative embodiments, the landing page may be displayed by another program. In the embodiment illustrated in FIG. 5, the Zapbuy Ad ID is determined from the URL (step 522), a cookie or other type of locally stored data associated with the user is retrieved (step 524), and the cookie, Ad ID, and information uniquely identifying the user's device, called the “device signature”, is sent to the Omnyway Backend (step 526). The Omnyway Backend checks to see if the received cookie matches any of the cookies that the Omnyway Backend has previously stored and associated with a particular user and/or device (step 528).

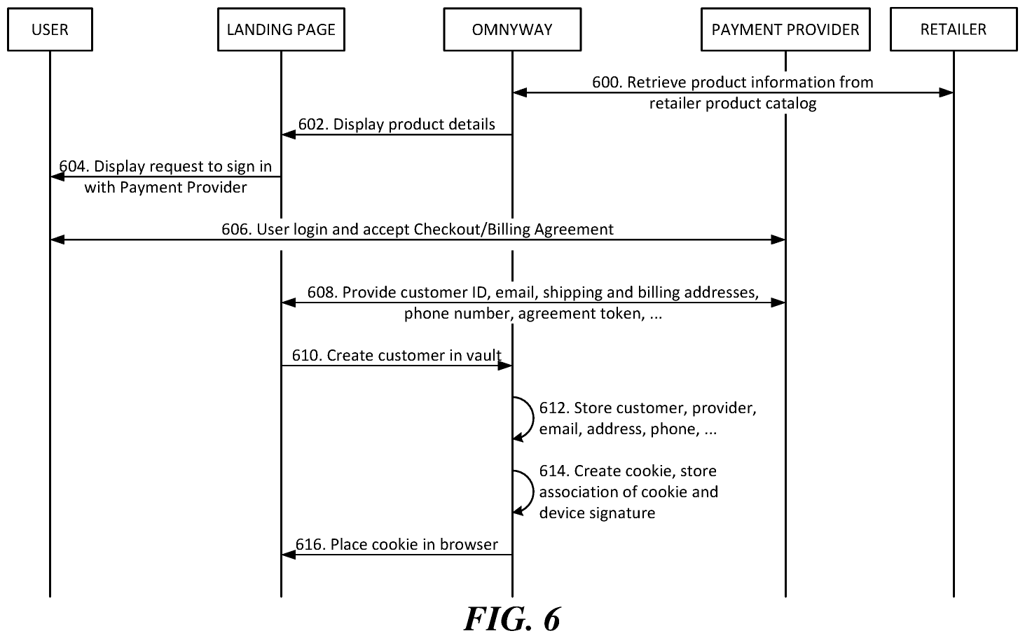

FIG. 6 is a signaling diagram illustrating an exemplary process for providing a targeted ad to a user according to some embodiments of the present disclosure, describing some of the events that occur for a new user, i.e., when, in step 528 of FIG. 5, the Omnyway Backend does not recognize the cookie that it received in step 526 of FIG. 5. In the embodiment illustrated in FIG. 6, the Omnyway Backend retrieves product information from a product catalog of the retailer that is offering the product or service that was the subject of the targeted ad (step 600). The Omnyway Backend displays the product details on the landing page (step 602). The landing page displays a request for the use to sign in with a payment provider (step 604), such as PayPal, Visa, etc. For example, the landing page may display a button or image which will initiate the sign-in process if the use clicks on it. In another example, the landing page may display a popup window or other prompt asking the user if they want to sign into the payment provider.

In the embodiment illustrated in FIG. 6, the user logs in with the payment provider and accepts a Checkout/Billing Agreement, which gives Omnyway permission to make charges to the user's payment instrument as part of the Zapbuy process (step 606). If the user does not have an account with the payment provider, this step would also include the signup process. After the user has completed step 606, the payment provider provides user information, such as the customer ID, user's email, shipping and billing addresses, phone number, etc., and an agreement token that identifies the quick Checkout/Billing Agreement contract, to the landing page (step 608). In the embodiment illustrated in FIG. 6, the landing page passes this information back to the Omnyway Backend (step 610) so that the Omnyway Backend can create an entry for that customer in a vault. In the embodiment illustrated in FIG. 6, this entails storing a customer ID, the payment provider information, the user's email, addresses, phone numbers, and so on (step 612), and then creating a cookie and storing the association of the cookie with the device signature (step 614). The Omnyway Backend then places the cookie in the browser (step 616).

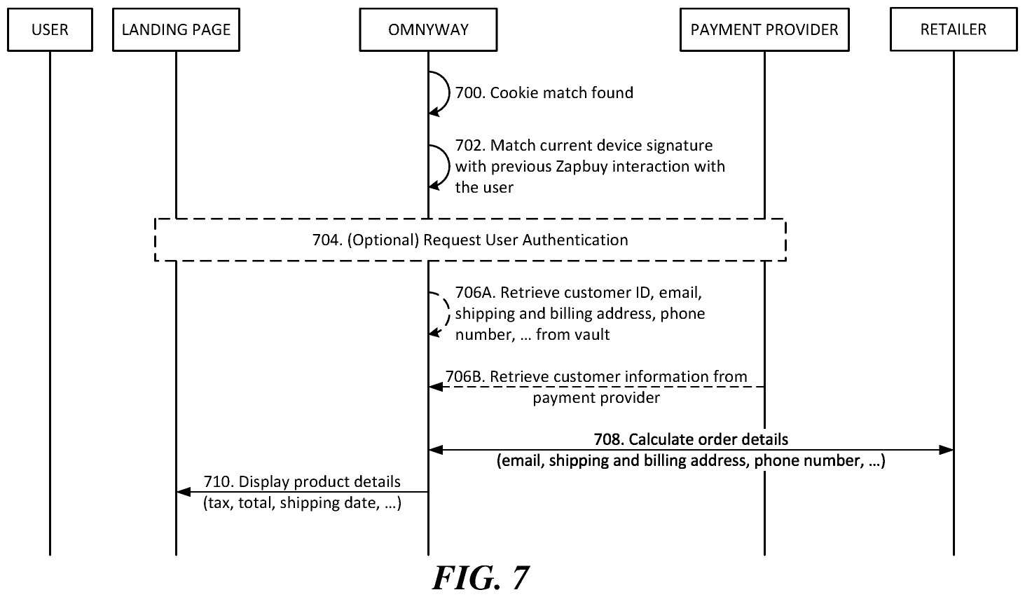

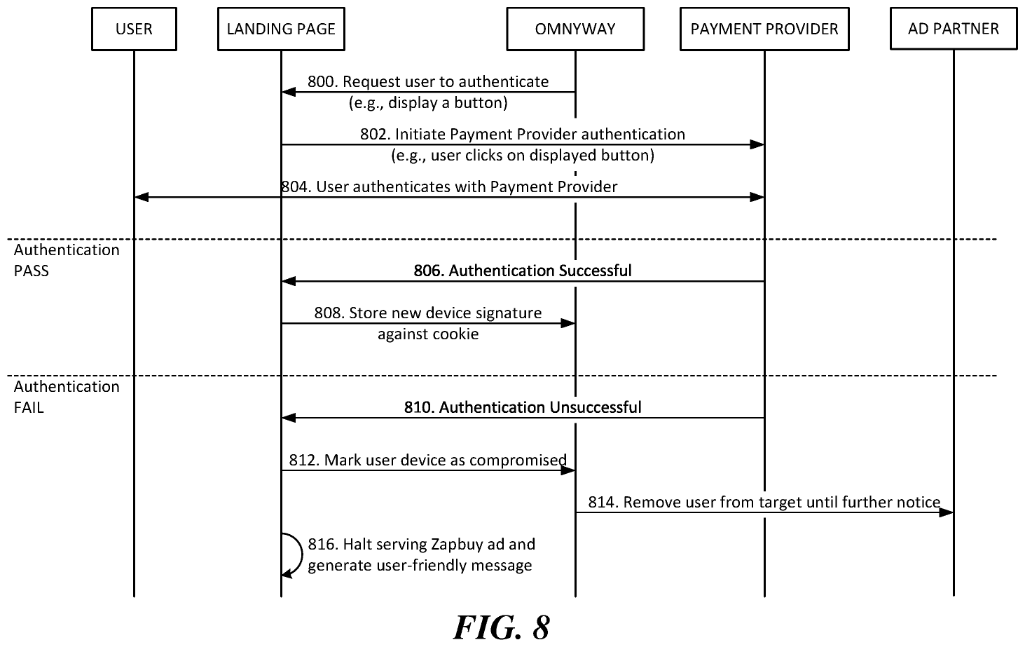

FIG. 7 is a signaling diagram illustrating an exemplary process for providing a targeted ad to a user according to some embodiments of the present disclosure, describing some of the events that occur for a returning user, i.e., when, in step 528 of FIG. 5, the Omnyway Backend recognizes the cookie that it received in step 526 of FIG. 5. In the embodiment illustrated in FIG. 7, the Omnyway Backend finds a match for the received cookie (step 700), then matches the current device signature with a previous Zapbuy interaction (step 702) with the user. If the returning user is determined to be “risky”, e.g., if the user is recognized but is determined to be a high risk user by Omnyway Backend, the Omnyway Backend may request user authentication (optional step 704), which is described in more detail in FIG. 8, below.

In the embodiment illustrated in FIG. 7, the Omnyway Backend retrieves user information per its customer ID, user email, shipping and/or billing addresses, phone number, etc., either from the vault (step 706A) or may get fresh from the payment provider (step 706B), then communicates with the retailer to calculate the order details (step 708). The user information may be used to calculate some of the product details. For example, the shipping costs of the product may vary depending on the user's shipping address. In some embodiments, the user preferences will be considered when calculating the order details. For example, the user may prefer to use less expensive ground shipping or just pick up at a nearby retailer store rather than using first class mail, which may lower the calculated cost of the product. Other user preferences may be used during the calculation of the order details. For example, the price of an item of clothing may vary depending on the user's size. Other customer-specific information may be considered during the calculation of order details. The product details, including calculated order details, are then displayed on the landing page (step 710).

FIG. 8 is a signaling diagram illustrating an exemplary process for providing a targeted ad to a user according to some embodiments of the present disclosure, describing some of the steps that occur during a request for user authentication in optional step 704 of FIG. 7. In the embodiment illustrated in FIG. 8, in response to determining that the user is “risky”, the Omnyway Backend sends to the landing page an instruction like a graphical button requesting the user to authenticate with the payment provider (step 800). Pressing or clicking the button initiates authentication with the payment provider (step 802), and the user authenticates with the payment provider (step 804).

In the embodiment illustrated in FIG. 8, if authentication is successful, the payment provider indicates this to the landing page (step 806), and the landing page instructs the Omnyway Backend to associate the new device signature with the cookie (step 808). If authentication is unsuccessful, however, the payment provider notifies the landing page of this fact (step 810), and the landing page instructs the Omnyway Backend to mark the user device as having been compromised (step 812). In the embodiment illustrated in FIG. 8, the Omnyway Backend responds by instructing the ad partner to remove the user from the target until further notice (step 814). The landing page, meanwhile, halts serving the Zapbuy ad. In some embodiments, the landing page generates a user-friendly message, e.g., to notify the user that the device is now being treated as compromised, to give the user instructions about how to contest this characterization, etc. (step 816). This prevents Zapbuy ads from being sent to users whose devices are compromised or to users who have exhibited suspicious or risky purchase behaviors.

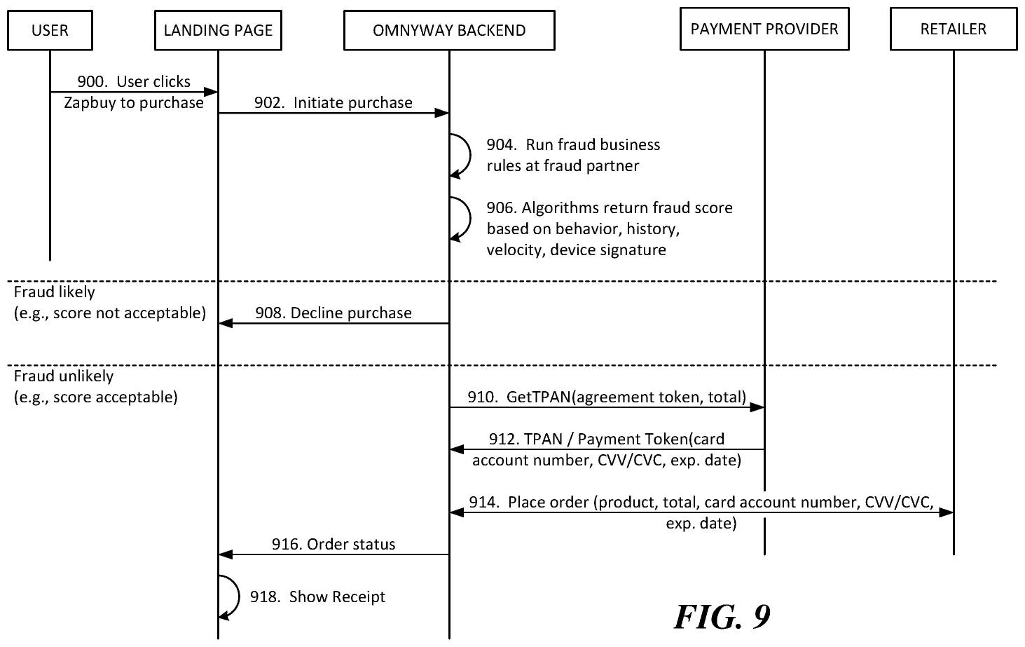

FIG. 9 is a signaling diagram illustrating an exemplary process for providing a targeted ad to a user according to some embodiments of the present disclosure, describing some of the steps that occur when the user takes advantage of Zapbuy, e.g., when the user clicks on the Zapbuy “buy now” button. In the embodiment illustrated in FIG. 9, the user clicks on the Zapbuy button or image (step 900). In response to detecting this user action, the landing page instructs the Omnyway Backend to initiate the purchase (step 902). In the embodiment illustrated in FIG. 9, the Omnyway Backend may run fraud business rules, e.g., on its own or via a service offered by a fraud detection partner (step 904). For example, in order to detect machine generated or fraudulent attacks, when the user clicks or touches the ad and the controls are passed to the Omnyway Backend, the Omnyway Backend may first confirm that the ad was indeed distributed to that specific user before responding positively to the user. In some embodiments, the algorithms return a fraud score based on behavior, history, velocity, device signature, or other factors (step 906).

In the embodiment illustrated in FIG. 9, if it is determined that fraud is likely (e.g., the fraud score was unacceptable), the Omnyway Backend declines the purchase and notifies the user of this fact via the landing page (step 908) and the process terminates. On the other hand, if it is determined that fraud is not likely, the Omnyway Backend requests a Tokenized Primary Account Number (TPAN) from the payment provider (step 910), the request including the agreement token (so that that payment provider has proof that the user gave permission for the Omnyway Backend to charge the user's account) and the total amount to be charged. In response to this request, the payment provider provides the TPAN/payment token (step 912), which represents the credit card number, the Card Verification Value/Card Verification Code (CVV/CVC), expiration date, etc.

In the embodiment illustrated in FIG. 9, the Omnyway Backend then places the order with the retailer (step 914), the order identifying the product, the total, the card account number, the CVV/CVC, the expiration date, and may also include other information usable by the retailer. The Omnyway Backend then notifies the user of the order status, which is displayed on the landing page (step 916). In the embodiment illustrated in FIG. 9, the landing page displays a receipt (step 918).

Once the user closes or dismisses the landing page, the user is then returned to whatever the user was doing prior to clicking on the Zapbuy ad. For example, if the user was browsing the web and clicked on the targeted ad, the user may be returned to the same page that displayed that ad. If the user was watching a video, listening to music, playing a game, or otherwise consuming content, once the Zapbuy purchase process ends (whether with or without having completed the purchase) the video, music, game, etc., may resume from wherever the user interrupted the stream in order to make the purchase. By making possible a single-step electronic transaction, the user can make a purchase and very quickly resume whatever activity the user was engaged in at the time; this not only makes it much more likely that the user will purchase the product, it makes it much more likely that the user will initiate the purchase sequence in the first place, e.g., because the user knows that the interruption time will be very short, thus helping to drive high conversion sale, and better returns for the retailer for every advertisement/marketing dollars it spends (ROAS—Return on Advertising Spend).

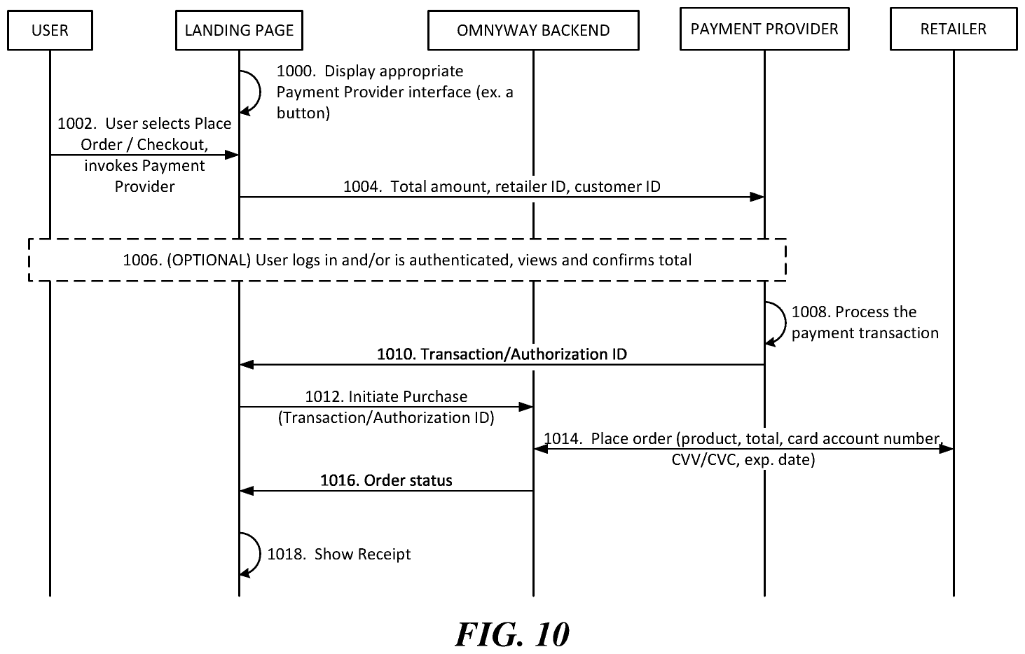

FIG. 10 is a signaling diagram illustrating an exemplary process for providing a targeted ad to a user according to other embodiments of the present disclosure, describing some of the steps that occur when the user takes advantage of Zapbuy, e.g., when the user clicks on the Zapbuy “buy now” button. In the embodiment illustrated in FIG. 10, the landing page displays an appropriate payment provider interface, such as a button, for example (step 1000). The user indicates a desire to place the order or checkout (step 1002), which invokes the payment provider, and, in response, the payment provider is supplied with the total amount, retailer ID, and customer ID (step 1004). In some embodiments, the user may optionally log into and/or be authenticated by the payment provider (step 1006), at which time the user may view and confirm the total.

In the embodiment illustrated in FIG. 10, the payment provider processes the payment transaction (step 1008) and sends the transaction/authorization ID back to the landing page (step 1010). The landing page then initiates the purchase (step 1012) by sending the transaction/authorization ID to the Omnyway Backend. The Omnyway Backend places the order with the retailer (step 1014). In the embodiment illustrated in FIG. 10, the Omnyway Backend supplies the retailer with information that identifies the product, the total, the card account number, CVV/CVC, expiration date, or other information needed to complete the order. The Omnyway Backend updates the landing page to show the order status (1016) and the landing page displays the receipt to the user (step 1018).

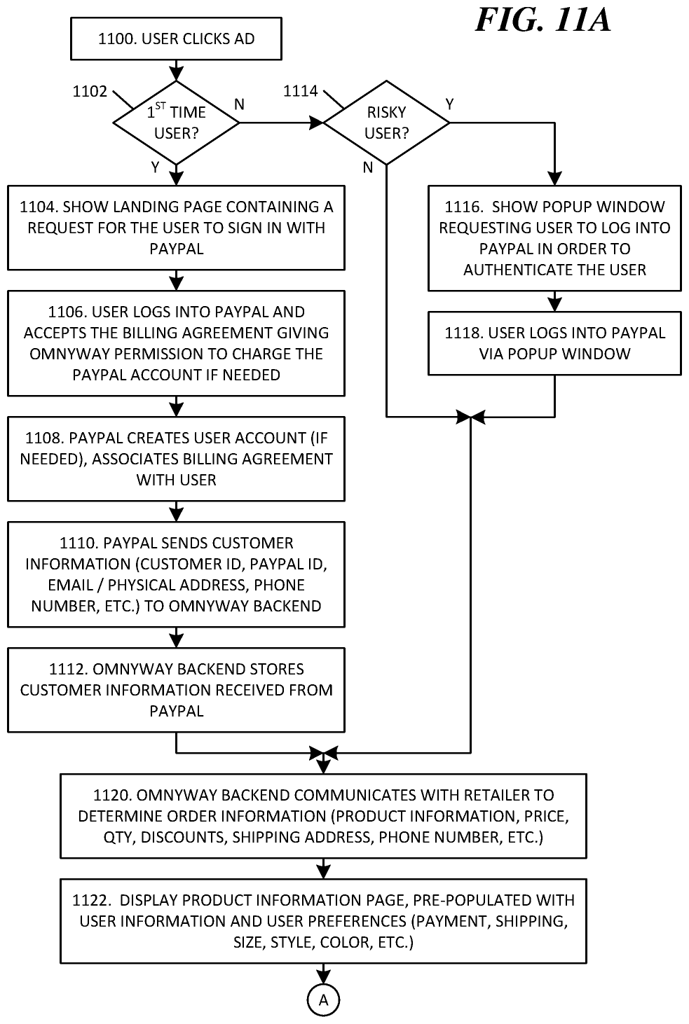

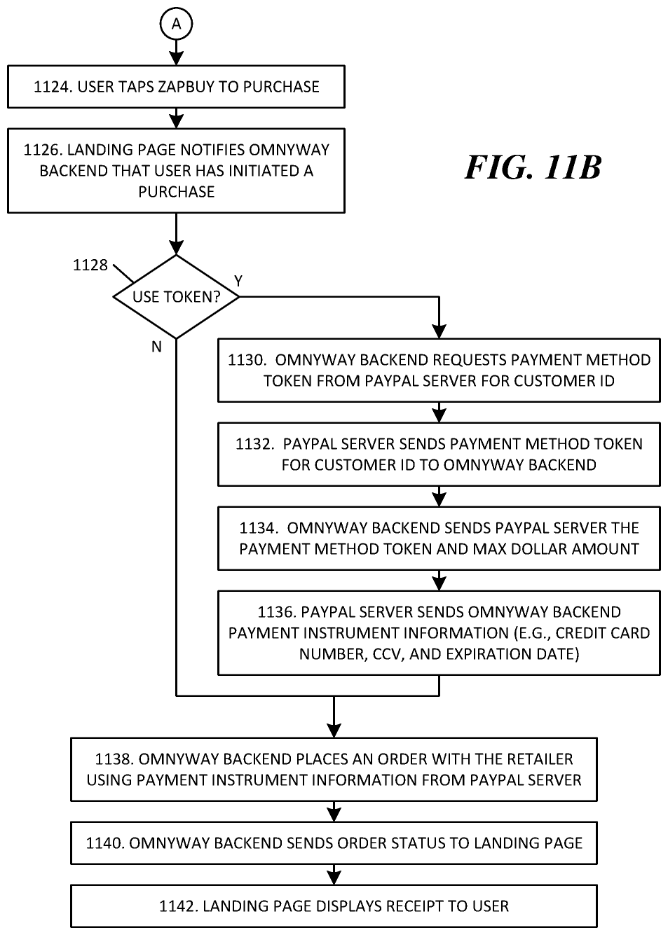

FIGS. 11A and 11B are flowcharts illustrating example flows in flowchart form rather than in as signaling diagrams according to some embodiments of the present disclosure. In the embodiment illustrated in FIG. 11A, the process starts when a user clicks an advertisement (step 1100). It is determined whether the user is a first time user or a returning user (step 1102).

If the user is a first time Zapbuy user, the user is shown a landing page containing a request for the user to sign in with PayPal (step 1104). The user logs into PayPal (and signs up for a PayPal account if the user does not already have an account), and accepts a Billing Agreement that gives Omnyway permission to charge to the PayPal account as part of a transaction (step 1106). If needed, PayPal creates a user if account, and associates the Billing Agreement with the user (step 1108). PayPal sends customer information (e.g., Customer ID, PayPal ID, the user's email address, the user's physical address, the user's phone number, etc.) to the Omnyway Backend (step 1110), which the Omnyway Backend stored (step 1112). The process then goes to step 1120, which will be described below.

If, at step 1102, it is determines that the user is a returning Zapbuy user, it is next determined whether the returning Zapbuy user is a high-risk PayPal user (step 1114). If so, the user will be presented with a popup window that requests the user to log into PayPal (step 1116). This is done in order to authenticate the PayPal user. The user logs into the PayPal via the login window and is thus authenticated (step 1018), and the process goes to step 1120. If, at step 1114, it is determined that the returning Zapbuy user is not a high-risk PayPal user, the steps 1116 and 1118 are skipped.

At step 1120, the Omnyway Backend communicates with the retailer to determine order information (e.g., product information, price, quantity, discounts, the buyers shipping address and telephone number, etc.), and at step 1122, the user is presented with a Product Details Page (PDP) that is pre-populated with user information and user preferences (payment option, shipping address, size, style, color, etc.) such that the user need only click a button on the PDP to initiate the purchase. The process continues in FIG. 11B.

Referring now to FIG. 11B, the user clicks the button (taps the icon, etc.) to initiate the purchase (step 1124). The landing page notifies the Omnyway Backend that the user has initiated a purchase (step 1126). It is determined whether the payment information involves the use of a token (step 1128), and if so, the Omnyway Backend makes a request for a payment method token associated with an indicated customer ID from the PayPal server (step 1130), and the PayPal server sends to the Omnyway Backend a payment method token that is associated with the customer ID (step 1132). The Omnyway Backend sends to the PayPal server the payment method token and specifies a maximum dollar amount and a time limit (e.g., three seconds) (step 1134), and the PayPal server sends to the Omnyway Backend payment instrument information, e.g., credit card number, CCV, and expiration date (step 1136). The process then goes to step 1138, described below.

If, at step 1128, it is determined that a token is not to be used, the process skips steps 1139, 1132, 1134, and 1136, and goes directly to step 1138. In step 1138, the Omnyway Backend places an order with the retailer using the payment instrument information received from the PayPal server. The Omnyway Backend then reports the status of the order, e.g., by sending it to the landing page (step 1140), and the landing page displays a receipt to the user (step 1142).

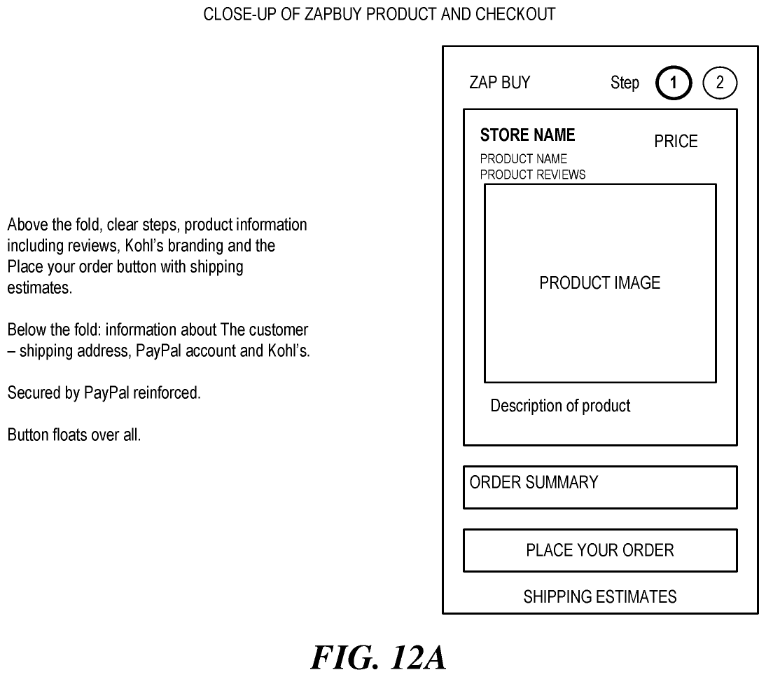

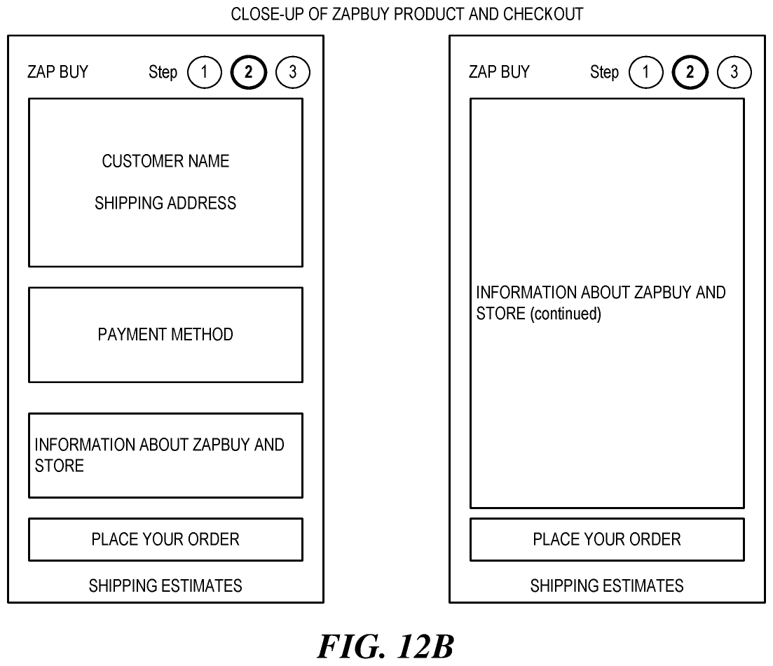

FIGS. 12A and 12B include screen shots showing a close-up of an example Zapbuy product description page and checkout.

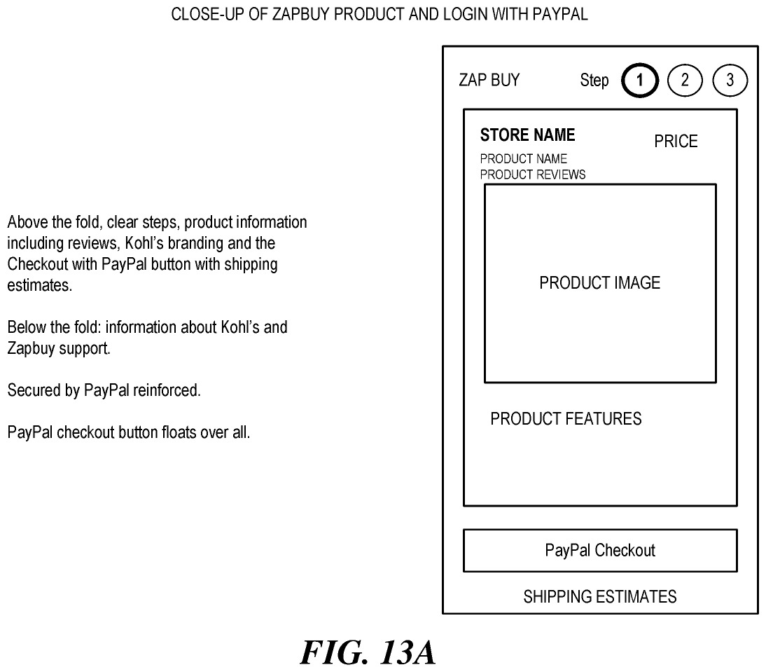

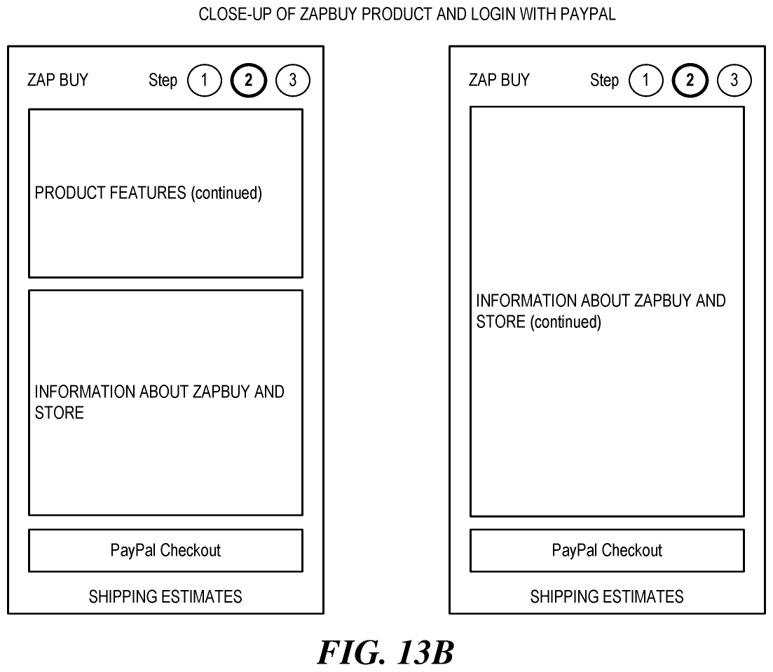

FIGS. 13A and 13B include screen shots showing a close-up of an example Zapbuy product description page and login with PayPal.

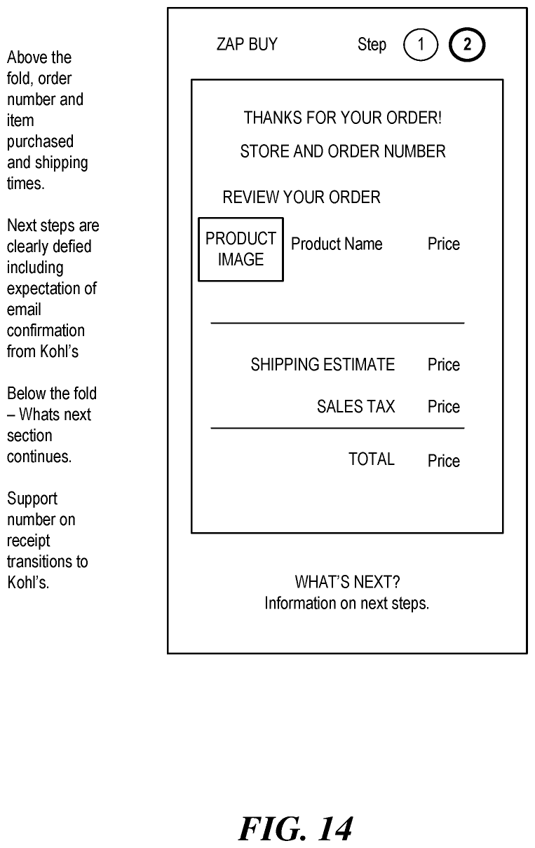

FIG. 14 includes a screen shot showing a close-up of an example Zapbuy receipt.

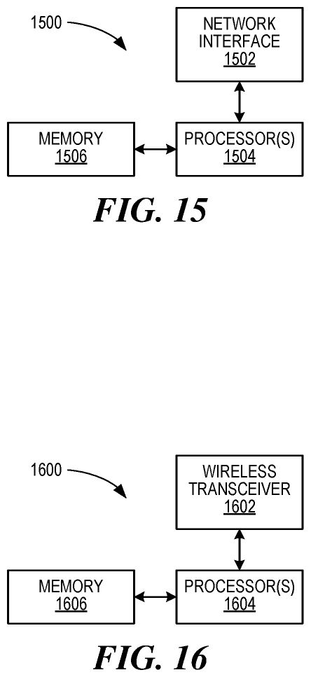

FIG. 15 is a block diagram showing an exemplary Omnyway Backend according to some embodiments of the present disclosure. In the embodiment illustrated in FIG. 15, an Omnyway Backend 1500 includes a network interface 1502 for communicating with a data or telecommunication network, one or more processors 1504, and memory 1506 for storing instructions which, when executed by the one or more processors 1504, cause the Omnyway Backend 1500 to operate according to any of the methods described herein.

FIG. 16 is a block diagram showing an exemplary user device, which may be a wired or wireless device and may be a mobile phone, wireless terminal, personal computer, smart device, smart speaker, or other electronic device, according to some embodiments of the present disclosure. In the embodiment illustrated in FIG. 16, a user device 1600 includes a wireless transceiver 1602 for communicating with a data or telecommunication network, one or more processors 1604, and memory 1606 for storing instructions which, when executed by the one or more processors 1604, cause the user device 1600 to operate according to any of the methods described herein.

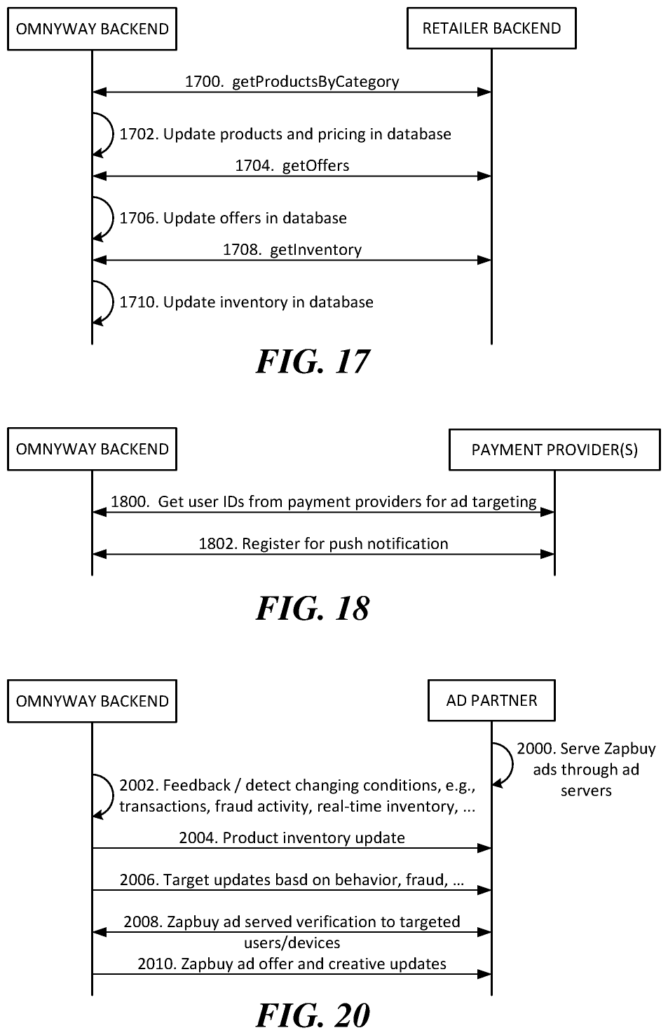

FIG. 17 is a signaling diagram illustrating an exemplary process for providing a targeted ad to a user according to some embodiments of the present disclosure, showing a portion of a process for setting up the Zapbuy backend. In the embodiment illustrated in FIG. 17, the Omnyway Backend may perform one or more of the following steps with each of one or more retailers that support the Zapbuy program: get a list of products by category (step 1700) and update products and pricing information in a database (step 1702); get a list of offers (step 1704) and update information about offers in the database (step 1706); and get a list of inventory (step 1708) and update information about inventory in the database (step 1710).

FIG. 18 is a signaling diagram illustrating an exemplary process for providing a targeted ad to a user according to some embodiments of the present disclosure, showing another portion of a process for setting up the Zapbuy backend. In the embodiment illustrated in FIG. 18, the Omnyway Backend may perform one or more of the following steps with each of one or more payment providers that support the Zapbuy program: get a list of user IDs from payment providers for ad targeting (step 1800) and register for push notification (step 1802).

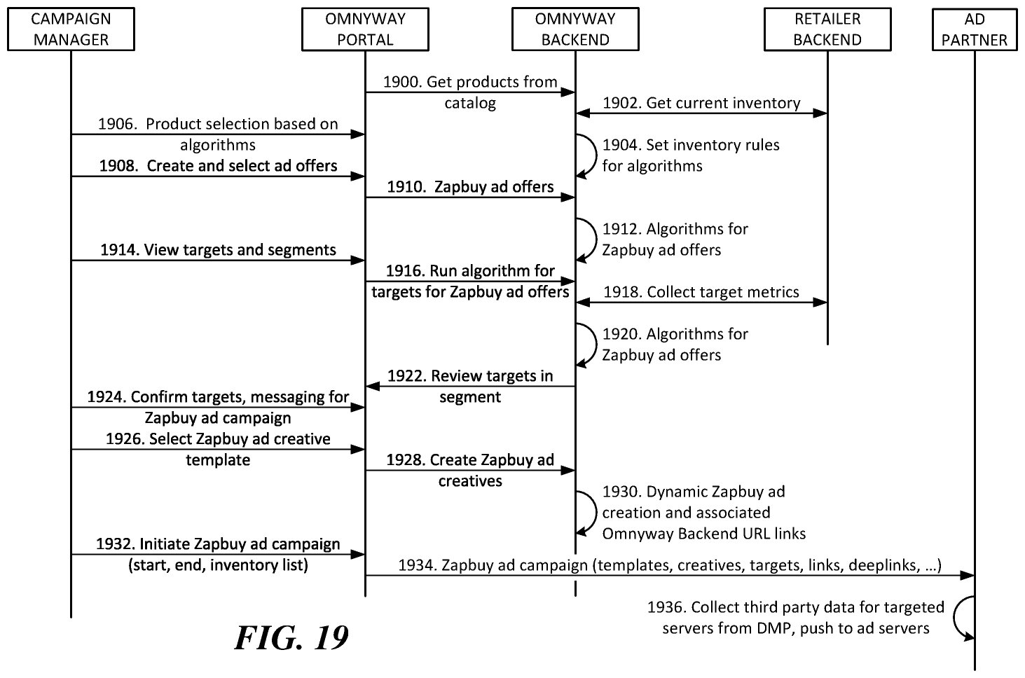

FIG. 19 is a signaling diagram illustrating an exemplary process for providing a targeted ad to a user according to some embodiments of the present disclosure, showing steps that may be performed to set up a Zapbuy campaign. In the embodiment illustrated in FIG. 19, the process starts when the Omnyway Backend receives a request to get products from the catalog (step 1900). In the embodiment illustrated in FIG. 19, the request comes from an Omnyway Portal. The Omnyway Backend communicates with one or more retailer Backends to get current inventory (step 1902), the sets inventory rules for algorithms (step 1904).

In the embodiment illustrated in FIG. 19, a Campaign Manager use the Omnyway Portal to make a product selection based on algorithms (step 1906) and to create and select ad offers (step 1908). The Omnyway Portal then communicates the Zapbuy ad offers to the Omnyway Backend (step 1910), which creates and/or uses algorithms for the Zapbuy ad offers (step 1912). The Campaign Manager may use the Omnyway Portal to view targets and segments (step 1914), and the Omnyway Portal instructs the Omnyway Backend to run algorithms for targets for Zapbuy ad offers (step 1916). The Omnyway Backend collects target metrics from the retailer Backend (step 1918), and uses those metrics to create and/or use algorithms for Zapbuy ad offers (step 1920). The Omnyway Backend then provides information to the Omnyway Portal so that the Campaign Manager can review targets in each segment (step 1922).

In the embodiment illustrated in FIG. 19, the Campaign Manager can use the Omnyway Portal to confirm the targets and set up the messaging for the Zapbuy ad campaign (step 1924). In the embodiment illustrated in FIG. 19, the Campaign Manager then uses the Omnyway Portal to select one or more Zapbuy ad creative templates (step 1926), and the Omnyway Portal instructs the Omnyway Backend to create the Zapbuy ad creatives (step 1928). The Omnyway Backend creates the dynamic Zapbuy ads and associated Omnyway Backend URL links (step 1930).

The Campaign Manager then initiates the Zapbuy ad campaign (step 1932). In the embodiment illustrated in FIG. 19, the Campaign Manager specifies when the campaign will start and end and also specifies the inventory list. The Omnyway Portal communicates the necessary information to the Ad Partner (step 1924). This information may include Zapbuy ad templates, creatives, targets, links, deeplinks, etc. The Ad Partner then engages in the campaign. In the embodiment illustrated in FIG. 19, the Ad Partner collects third party data for targeted servers and pushes the ads to ad servers (step 1936).

FIG. 20 is a signaling diagram illustrating an exemplary process for providing a targeted ad to a user according to some embodiments of the present disclosure, showing steps that may be performed to during operation of a Zapbuy campaign. In the embodiment illustrated in FIG. 20, the Ad Partner is serving Zapbuy ads through ad servers (step 2000). During the campaign, the Omnyway Backend may receive feedback or detect changing conditions, e.g., related to transaction activity, fraud activity, real-time inventory status updates, etc. (step 2002). In the embodiment illustrated in FIG. 20, the Omnyway Backend may respond by requesting a product inventory update (step 2004) and/or by targeting updates based on behavior or other transaction activity, based on fraud activity, and so on (step 2006). The Omnyway Backend and the Ad Partner may communicate to verify whether or not ads are being served to targeted users and/or devices (step 2008). The Omnyway Backend may send the Ad Partner new Zapbuy ad offers, creatives updates, or other information to update, modify, tweak, or tune the currently running ad campaign (step 2010).

In some embodiments, the ad, the landing page, and/or the product information page may display the payment instrument network or card issuer brand name and/or image.

### General Flow

The following is a general description of the features and functions of the methods and systems described herein. The following is illustrative and not limiting.

Presentation of the Advertisement. In one embodiment, the process begins with an advertisement being presented to or being made available to a user, e.g., a “Buy Now” advertisement may be displayed on a user device. For example, an advertisement may be displayed within a generic, standard, or non-custom application, such as a web browser, social media page, messaging app, text message, email, etc., or within a custom application/customer application, such as a banking app, social media app, retailer app, enterprise app, manufacturer app, service app, etc., or any other application on the user's mobile phone, computer, or other electronic device; the advertisement may be displayed during a movie, a video, a song, or other streaming content; the advertisement may be presented as a result of a search, including a voice-activated search or other voice command, or text typed search; the advertisement can be an image, text, or any object displayed, whether or not it looks like an ad. The advertisement may be for a tangible or intangible item or service, which may be referred to herein generically as “the item”, “the product”, etc. The advertisement could be displayed or played on a consumer device like a mobile device, tablet, portable computer, a desktop computer, a TV, radio, or a consumer wearable like watch.

Targeted or non-targeted. The ad may be non-targeted, or the ad may be targeted to select or selected users, e.g., based on a determination that the user: is a holder of one or more specific payment instruments (e.g., PayPal, Visa, Mastercard, Amex, Discover, Citi, Bank of America, Chase, Alipay, WeChat Pay, Venmo, etc.); is or could be interested in purchasing one or more product and/or a service types; and/or has previously purchased and/or opt-in for the “Buy Now” advertising service. The ad may show branding information (also referred to herein as “brand information” or “brand identity”), which is information that identifies a brand, such as a company name, logo, trademark, or other identifier associated with the brand. The ad may show branding information for the seller of the advertised product, for the payment instrument provider, such as a PayPal logo, an image of a Visa card, etc., and/or for Omnyway.

Targeting may be accomplished using various algorithms, including, but not limited to: algorithms provided by the seller or the payment provider; media affinity algorithms; pricing selection and optimization algorithms; and/or product selection process algorithms. In some embodiments, the system my implement a feedback loop for high conversion sales. For example, the system may dynamically modify its behavior in response to detected user behaviors, changing fraud scores, as well as changes to inventory status, network status, etc. In some embodiments, the system generates ads in real-time for spontaneous purchases.

Indication of user interest. The user then indicates an interest in the product, such as by clicking on or touching an image of the product on the screen of an electronic device, by scanning or taking a picture of the item using a mobile phone, through a voice response, or other means. In one example, a user may ask an electronic assistant such as Siri™ or Alexa™ for information and may be presented with one or more products. The user may indicate an interest in a particular product by touching or clicking on the screen or by giving a voice command (e.g., “Buy that item”). In another example, a user viewing a video or an advertisement may use voice-based commands to place an order for a product being displayed in the video.

Presentation of “Buy Now” information. In response to the user indicating an interest in the product, “Buy Now” information is presented.

Visually. In one example, a Product Description Page (PDP) may be displayed to the user, showing a description of the product, a payment instrument, a price, and a button or other mechanism by which the user can initiate the purchase or electronic transaction with minimal effort, e.g., by clicking a “Buy Now” button. A PDP page with a Buy Now button is referred to herein as a “Buy Now page”. Other information may be displayed as well, such as additional product information, seller-specific information, payment instrument-specific information, Omnyway-specific information, and user-specific information. The Buy Now page may include branding information for the merchant, the payment instrument provider, and/or Omnyway. Where the Buy Now page is provided to the user as a result of an interaction with a banking, social network, or other type of mobile app which embeds the Omnyway functionality within it, the Buy Now page may be branded with the logo of the mobile app or other brand information. Where the Buy Now page is presented as part of an interaction with a retailer's mobile app, the Buy Now page may include the retailer's brand information.

Examples of user-specific information may include a pre-selected or default payment instrument with an option to change the default if the user desires; default billing and shipping information, which may be provided by an Omnyway Backend, by the merchant, by the payment instrument provider, or other source; and/or any other information that may be necessary to complete a purchase—retrieved and applied for the user so that the user need only click the “Buy Now” button to complete the purchase, e.g., all other information having been pre-populated by the system where possible.

Other examples of user-specific information include the application of user preferences with regard to the item or the transaction. For example, if the product is an article of clothing, the Omnyway Backend may automatically select the user's size, preferred style or color, and so on. This information may have been provided by the user explicitly and/or determined implicitly, e.g., based on previous purchase histories, previous search queries, or other indicia of consumer interest.

Notably, the Buy Now page is presented to the user directly, i.e., the user is NOT taken to a retailer's website, nor is the user required to open another application. In some embodiments, another application is not automatically opened on behalf of the user, but instead the existing platform (browser, mobile app, banking app, social media app, streaming content server, and so on) by which the ad was made available to the user is used to make the Buy Now page available to the user. Where the user is using a browser, a new browser window may be displayed with the Buy Now page. In another example, a user may be watching streaming content which is interrupted to display an ad for a product; if the user is interested in that product, a Buy Now page is displayed to the user, either as a new pop-up window or displayed where the streaming content had been displayed. The user can purchase the product, after which the user is then returned to the streaming content.

Verbally/Aurally. In another example, a user asks an electronic assistant to identify restaurants that deliver food to the user's location; the user is told that a local restaurant is offering a buy-one, get-one free deal and is asked if the user is interested; the user indicates interest, and the user is presented with the same kinds of information that would be provided on a Buy Now page, but aurally, e.g., a description of the item, the selected payment instrument, the cost, etc. If the user gives a verbal assent, this triggers the transaction. In this example there is not Buy Now page because the notification and information was aural, not visual. Thus, the Buy Now information may be displayed in response to an interaction with an electronic device, including giving and receiving voice commands.

Pre-populated. The Buy Now information (page, speech, or other) is generated by the Omnyway system, which may include one or more servers connected to data and/or telecommunication networks. The information provided by the Omnyway system may come from its own secure storage, e.g., from Payment Card Industry (PCI) Data Security Standard (DSS)-compliant storage. Some information, such as billing address, shipping address, default payment instrument, etc., may be supplied by the payment instrument provider. Some information, such as user size or other user preferences, may be supplied by the merchant or product seller.

For a first time user: The user may be displayed with a list of payment options (e.g., PayPal, Visa, Mastercard, Masterpass, Discover, Amex, Venmo, Alipay, WeChat Pay, Apple Pay, Samsung Pay, LG Pay, Citi, Chase, Bank of America, HSBC, other payment types, etc.). This list may or may not be tailored to include payment instruments known to be possessed by the user, e.g., such as when the Buy Now page is displayed as a result of an interaction with a banking app, in which case the user presumably is known to have a bank card or credit card issued by Visa, Mastercard, etc.

The user then selects a payment instrument, and the Omnyway system passes the user interaction to the selected payment network or issuer (e.g., PayPal, Visa, etc.), where the user may be given the opportunity to create a new account and/or log into an existing account. Once an account is extant, the user may be authenticated, e.g., through username/email & password, biometric, multi-factor authentication, etc. Where the transaction is the result of a voice command, a verbal authentication may be performed, e.g., the user is prompted to provide a PIN, password, or other authenticating information, the user's voice print may be analyzed or other voice recognition may be performed, etc.

The payment network and/or issuer then provides the Omnyway system with user information, such as name, payment information (account #, token, cryptography information, expiration date, and/or 3 digit security code, additional EMV data, etc.), shipping address, email, phone number, etc., to the Omnyway system, so that the user doesn't have to manually enter it. The selected payment type will then be used for the first transaction, and may be stored as the default for future transactions.

The user may be asked to sign an agreement (e.g., an End User License Agreement, or EULA) or otherwise give permission for the Omnyway system to charge the user's card every time the user uses Zapbuy in the future so that we don't have to ask every time.

For a returning user: A payment instrument provider may have a streamlined payment arrangement that the Omnyway system can take advantage of. For example, PayPal has a one-touch option such that PayPal does not require the user to login again, so-called “friction-less authentication”, after that initial sign-in. The user may be authenticated in a variety of ways, including, but not limited to: by the Omnyway Backend, e.g., using multi-factor authentication using its own tracking information on user and device; using user-selected payment issuer authentication and risk management information; using third-party authentication and risk management information; using user device-based biometrics; using modality and behavioral authentication, and other methods. In some embodiments, a user that is determined to be at elevated risk, such as when a returning user is identified but the device which the user is using is not known to the system (or upon detection of other indicia of possible fraudulent activity), the user may be redirected to a login page for the user's payment provider; if payment provider notifies the Omnyway Backend that the user successfully logged into the payment provider's website, the Omnyway system may presume that the user has been authenticated. Once the user is identified, then name, already selected (default) payment information, shipping address, email, phone number, shipping options, are displayed on “buy now” product page by Omnyway.

Any time: The Buy Now information may also include an option for the user to pick up the item at the store or have the item delivered to a preset or custom location. The user may have the opportunity to override any of the defaults. Where a finite list of alternative is available, the user may be provided with a means to select from such a list. For example, the user may choose a size, color, or other provided product option; a shipping preference, e.g., priority, overnight, ground, etc.; a shipping address option; and so on. These options may be implemented as a button on a Buy Now page, a verbal prompt in a voice-command implementation, or other means. In some embodiments, the Buy Now page may provide an opportunity for the user to be presented with additional purchase choices, such as, but not limited to, bundles, “you may like” items, “other customer also bought” items, or other special offers. In some embodiments, these offers may be algorithmically selected, e.g., based any metric available to the system, including, but not limited to, user preferences, user purchase history, general or individual trends, inventory levels, etc. The recommended items may be provided by the same retailer that is the source of the specific item which the user indicated an interest in purchasing, or it may be from another seller, e.g., from a non-competitive seller.

Purchase action. User responds to “Buy Now” ad displayed by an application with indication to purchase, e.g., triggering a Buy Now button using touch, mouse, or keyboard, using a voice-based command, making a gesture using a mouse, virtual reality controller, etc. while staying in her current context—where the user responds to an Ad and completes a purchase in fewer steps without having to visit a seller ecommerce website. The Omnyway system initiates and/or handles the transaction and then presents to user with confirmation of the transaction, which may be a receipt, estimated date of delivery, or other information. Where the transaction is a result of a voice-based product search or other voice command, the confirmation may also be a verbal confirmation made to the user by the electronic assistant or other source. In some implementations the Omnyway system completes the order as placed by the user by identifying a preselected payment instrument, shipping address, contact information of the user from a financial institution, payment network provider, or wallet provider, and sending it along with the product information as selected by the user to the seller (retailer, distributor, service provider, marketplace, brand, manufacturer, or any type of seller) using the seller's or third party (representing a seller) fulfillment APIs.

In some embodiments, after the purchase action is completed, the user may be presented with additional products to purchase, e.g., “recommended for you”, “other customers also bought”, etc., from the same seller or from another (usually non-competitive) seller.

User stays in the original context. After completion (or cancellation) of the purchase(s), the user returns to the original content, e.g., the Pay Now web browser window will close and the user finds herself to the displayed window where she found the Ad, the Pay Now information will close and the user will continue to watch the streaming content previously being watched, the electronic assistant will complete the purchase and resume whatever it was previously doing, such as playing music or radio, television, video, or internet programming, and so on. Thus, for returning, low-risk users, once the user indicates interest in an item or product in an ad, the user can complete the purchase in just one action—whether it be a click, a touch, a verbal command, a keystroke, or other action by the user—because all of the information needed for the purchase is collected and used to prepopulate the offer that is displayed to the user and the user need only take the one action to make the purchase happen.

### System Diagrams

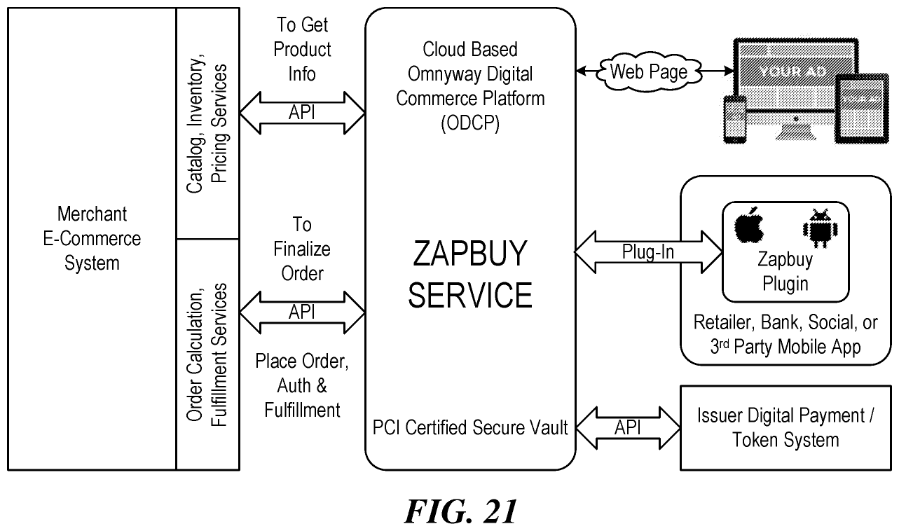

FIGS. 21 through 24 are block diagrams illustrating an exemplary system for providing a targeted advertisement (“ad”) to a user according to some embodiments of the present disclosure

FIG. 21 provides an overview of the system. In the embodiment illustrated in FIG. 21, the Zapbuy service is hosted by the Omnyway Digital Commerce Platform (ODCP), which may be a cloud-based platform, that interacts with merchant e-commerce/digital systems, e.g., via APIs into the merchant's catalog, inventory, and order calculation services, the merchant's fulfillment services, and the like. The ODCP may communicate with Omnyway Zapbuy plugins (or other “app-in-app” entities) operating with, e.g., bank/issuer mobile apps, and the ODCP may communicate directly with banks and issuers. The ODCP may communicate with marketing channel entities, for example, to provide information, rules, filters, or other guidance, e.g., to help target ads. The marketing channel entities place the advertisements, e.g., on webpages, within streaming content, and so on. When the user indicates interest in a product (as described above, for example), that notification typically is transmitted to the ODCP via the internet.

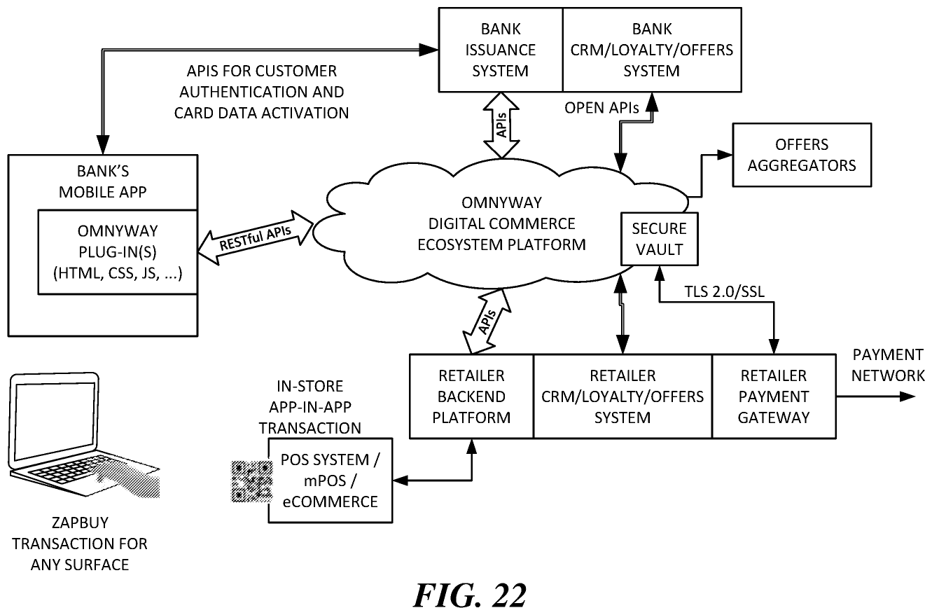

FIG. 22 illustrates another aspect of the present disclosure, e.g., other communication paths between the ODCP and various entities.

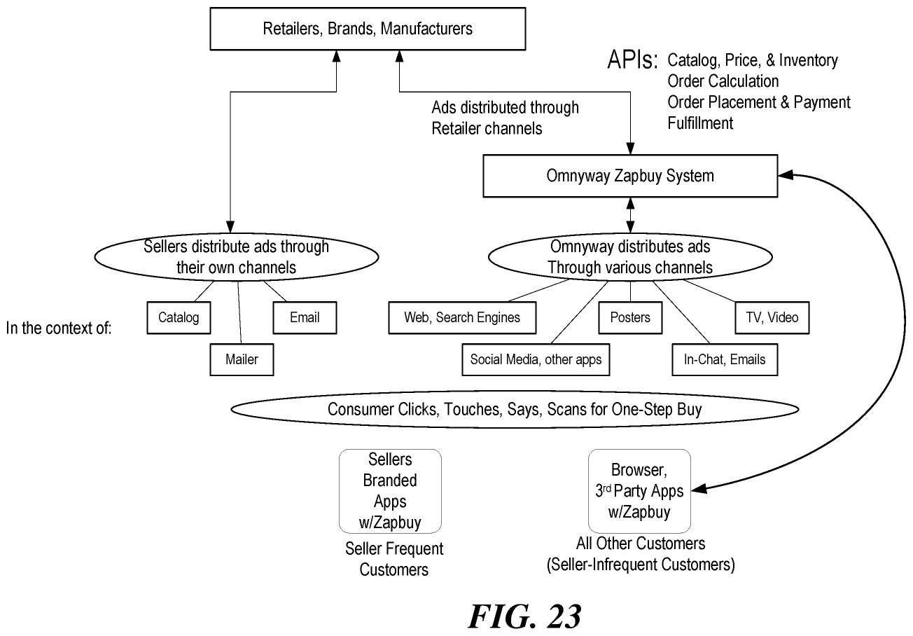

FIG. 23 illustrates yet another aspect of the present disclosure, e.g., other communication paths between the ODCP and various entities.

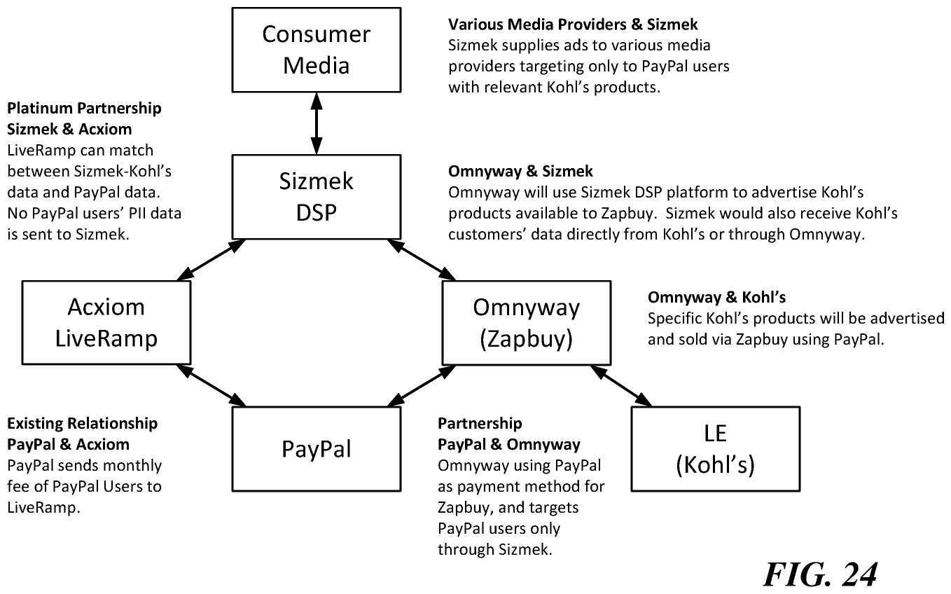

FIG. 24 illustrates yet another aspect of the present disclosure, e.g., some relationships between the ODCP and various entities.

### Example Algorithms

Algorithms and machine learning aspects of Zapbuy manage a complete process of advertising a product on behalf of one or more sellers (retailers, service providers, manufacturers, brands, marketplaces, distributors, or any type of seller) from product selection through the successful completion of its sale (product purchase, services, subscriptions), while delivering a seamless one-action (one-click, one-say “buy now”, one-scan) shopping experience within the existing customer context. In some embodiments, the system drives the product Ads and monitors the product selections, creative generations, UI experiences, and other factors vs the resulting sales for a product Ad, and over time self-corrects the algorithms and underlying processes to achieve the highest possible conversion sales for a product Ad. Algorithms and machine learning are present in the following aspects of the Zapbuy system:
1) Product selection from the seller product catalog: The sellers' product catalogs are vast, and in order to make sure the best products are selected for Ad based single click purchase by one or more targeted consumers, the Omnyway Backend uses a set of highly automated and intelligent processes resulting in high conversion sales.
   a. Initial data/model build: Based on business rules, a variety of input features and past shopper behavior, current trends, select from the sellers the best products and deals to display in the ads.
   b. Behavioral modeling around successful one-click purchases: 1) Correct and catchy product selection for impulse buying decision incorporating influencing factors that result in spontaneous purchasing decisions 2) Trust in the brands (sellers and payment providers) to feel confident in making the purchase, 3) Minimum (one-click) steps involved to complete the purchase from the product Ad while staying within the shopper's current context.
   c. Ongoing data tuning: Collect signals from the click/no click, buy/no buy to pass back into the production selection algorithm. One exemplary algorithm uses machine learning to boost successful products/deals and lower less successful products/deals based on the consumer behavior and other input features.
   d. Automated image generation for ad creatives optimized for one-click purchase: Compose various elements into a variety of creative media formats and sizes and make the participating brands (sellers and payment providers) prominent to gain consumer trust and facilitate quick buy decisions.
   e. Ongoing ad creative tuning: Collect signals from the shopper behavior back into the creative generation process. One exemplary algorithm uses machine learning to boost successful creatives and lower less successful creatives based on the consumer behavior and other input features.
2) AB testing system focused on the testing and measurement of conversion events from display advertising to purchases. Use to measure impacts of new UI, products, product selection and creative generation algorithms, promotions/deals, pricing or audience features to the system to produce higher conversions.
3) 360-degree view data collection and modeling: Data collection across all of the Zapbuy sellers, payment providers, media providers, current trends, current conditions, current seasons, current shopper context gives the models a 360-degree view of the shoppers' behavior and situation. This data will be used to drive the following models to increase conversions from the product Ads via one-click purchase within the existing customer context:
   a. Promotion selection: Measure and tune to find the best promotion level by product, audience and influencing factors. Real-time feedback of click/buy events drive machine learning to boost successful promotions while lowering the use of less successful promotions to increase one click conversions.
   b. Influencing Factors for one-click purchase of seller products, services, and subscriptions: Data collection across all of the Zapbuy sellers, payment providers, media providers, current trends, current conditions, current seasons, current shopper context (including current or past Zapbuy behavior) to identify and model those factors that drive the successful one-click purchase of the sellers' products.
   c. Trusting factors for one-click purchase of seller products, services, and subscriptions through the Zapbuy system: Using AB testing and feedback (click/purchase events) measure and model factors that determine trust among the brands, payments or context (e.g., publishing sites), algorithms will boost those combinations that perform better and lower those combinations that perform poorly. For example, some mobile ads do not have room for trust branding—the machine learning algorithms may try to determine whether the visibility or non-visibility of the trust brand is changing the conversion rate.
   d. User Interface mechanism modeling for one-action (one-click, one-say “buy now”, one-scan) purchases: Model the effectiveness of web, video, audio, smart I/O devices like Alexa, Google home, smart watch, scan, TOT buy button interfaces on quick buy decisions.
   e. Recommendations: Use a variety of modeling techniques (i.e., causal and correlation, collaborative filtering, contextual) to select additional products to present for purchase during or right after a Zapbuy purchase to increase total sales and share of wallet.
   f. Bundling: Use frequently bought together modeling techniques to find and recommend an option with additional products/deals with bundle pricing for purchase to increase the item count in the cart for the current Zapbuy session.
   g. Customized and Personalized Products/Deals: Use combination of the above recommendation, bundling and promotion techniques to create a personalized experience with a variety of products and promotions from one or more sellers. This experience is outside the Ad channel with a user interface starting point of web, video, audio, smart I/O devices like Alexa, Google home, smart watch, scan, IOT buy buttons. The products/deals returned to the shopper are personalized and optimized for one-action (one-click, one-say “buy now”, one-scan) purchases.
   h. Customer modeling: Algorithms to identify important features and context for existing shoppers' positive and negative behaviors. Map new shoppers' features to quickly model and predict the products/deals and pricing preferences. Use real-time feedback to continuously measure and adapt the model behavior to increase the conversions.
   i. Affiliates: Model/API to insert affiliate ads (new channel) from other sellers into purchase confirmations communications by a seller (post purchase communications). Use business rules, attractive and repellant feature modelling to create cross seller recommendations, bundles and special prices to increase conversion within and awareness of Zapbuy system and network of sellers.
   j. Bonus/Incentives Modeling: Develop models to test a variety of incentives to determine the successful features around behaviors such as liking, sharing, allowing push notifications, using retailer services like BOPIS. Model intent to increase awareness of Zapbuy system to bring more shoppers into Zapbuy.
   k. Affinity modeling: Media to payment provider, Media to Seller, payment provider to Seller, and Product Affinity Modeling: Develop models to map and predict certain affinities between certain media placements, sellers, products and payment providers to increase conversions for one-action (one-click, one-“say-buy-now”, one-scan) purchases. Real-time event collection boosts successful product Ad placements and lowers less successful product Ad placements.

### Embodiments

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein.

### Returning, Trusted User

Embodiment 1. A system for performing an enriched advertisement-based single-step electronic transaction comprises a database for storing and maintaining payment information for users and a backend server. The backend server receives an indication that a user is interested in a product in an advertisement that was presented to the user, and responds by generating transaction information and presenting it to the user. The transaction information includes product information, payment instrument information, shipping information, and/or other information associated with the transaction, presented in a manner such that the user need only perform a single step (e.g., clicking a button, touching a screen, giving verbal consent, etc.) in order to trigger the transaction. Upon detecting that the user has performed the single step, the backend server initiates the transaction, e.g., by sending the transaction and payment information directly or indirectly to relevant parties for payment processing and fulfilment of the ecommerce transaction, and notifies the user of the result of the transaction.

Embodiment 2. The system of embodiment 1 wherein presenting the transaction information to the user comprises generating and presenting to the user a landing page that includes the transaction information along with a button or image which the user can click or touch to initiate the transaction.

### Returning, Untrusted User

Embodiment 3. The system of embodiment 1 wherein the backend server determines that the user is a returning, untrusted user, and, in response to determining that the user is a returning, untrusted user: requests the user to authenticate with the payment provider; and receives an indication of the result.

Embodiment 4. The system of embodiment 3 wherein determining that the user is a returning, untrusted user comprises determining that the user identity is known but the user device is not associated with the user or determining that the user has engaged in potentially fraudulent activity.

Embodiment 5. The system of embodiment 4 wherein receiving an indication of the result comprises receiving an indication that the authentication was successful and wherein the backend server associates the device with the user.

Embodiment 6. The system of embodiment 4 wherein receiving an indication of the result comprises receiving an indication that the authentication was unsuccessful and wherein the backend server marks the user device as being compromised.

### New User

Embodiment 7. The system of embodiment 1 wherein the backend server determines that the user is a new user, and, in response to determining that the user is a new user, the backend server: requests the user to sign in with a payment provider and accept a checking/billing agreement that allows the backend server and/or seller to make payments on behalf of the user via the user's payment provider account; stores customer information for the user; generates a cookie or other tracking information; and stores an association of the cookie and a device signature of the device used by the user.

Embodiment 8. The system of embodiment 7 wherein the backend server further provides the cookie and/or java script to the landing page.

### Targeted Ad Placement

Embodiment 9. The system of any previous embodiment wherein the advertisement that was presented to the user was presented by an Advertising Partner that: detected an association between the user and a payment provider; matched the user to an advertising campaign segment; filtered the user based on past user behavior; filtered the user based on a fraud score and/or user history of behaviors; matched the product based on user interest history; retrieved the ad creative that includes a backend server URL; and placed the targeted ad into content being consumed by the user. Once a user selects an enriched Ad, product being advertised is presented based on prediction of interest in the product using various contextual parameters, e.g., where the user is (at home, or at work), what the user is doing (what type of contents the user is reading), etc.

### Initiating the Purchase

Embodiment 10. The system of any previous embodiment wherein initiating the purchase comprises: running fraud business rules locally or at a fraud partner; determining a fraud score based on behavior, history, velocity, and/or device signature; upon a determination that fraud is likely, declining the purchase; and, upon a determination that fraud is not likely, initiating a transaction with the payment provider.

Embodiment 11. The system of embodiment 10 wherein initiating the transaction with the payment provider comprises: 1) retrieving payment information from the payment provider; placing the order; reporting the order status to the user; and displaying a receipt to the user, or 2) providing transaction amount, customer ID, seller ID, etc. to Payment provider to process payment transaction, and the payment provider provides back Transaction/Authorization ID, Transaction Amount, and retailer ID back to the System.

Embodiment 12. The system of embodiment 11 wherein retrieving payment information from the payment provider comprises: requesting a Tokenized Primary Account Number (TPAN) from the payment provider, the request identifying the checkout/billing agreement and a transaction total; and receiving the TPAN representing the card account number, CVV/CVC, and expiration date, which are used when placing the order.

### Dynamic Updates

Embodiment 13. The system of any prior embodiment wherein the backend server detects an update trigger event, and in response performs at least one of: requests a list of products from a retailer backend and updates product and pricing information maintained by the backend server; requests a list of offers from the retailer backend and updates offer information maintained by the backend server; requests a list of available inventory form the retailer backend and updates inventory information maintained by the backend server.

Embodiment 14. The system of embodiment 11 or embodiment 13, wherein an update trigger event comprises: creation of a new ad campaign; and/or detecting a change in products, offers, or inventory status.

Embodiment 15. The system of any prior embodiment wherein the backend server: requests from a payment provider a list of user IDs for ad targeting; and registers for push notification from the payment provider.

Embodiment 16. The system of any prior embodiment wherein, during an ad campaign wherein an advertising partner is serving ads through ad servers, the backend server receives feedback or detects changing conditions, and in response: requests a product inventory update; targets updates based on behavior, fraud or other condition or trend; receives verification that ads are being served to targeted users/devices; and/or sends ad offers and creative updates to the ad partner.

### Setting Up an Ad Campaign

Embodiment 17. The system of any prior embodiment wherein the backend server: receives, from a campaign manager, a request to get products from a catalogue, gets current inventory from a retailer backend, and applies inventory rules for algorithms; receives ad offers, and applies algorithms for the ad offers; receives a request to run algorithms for targets for ad offers, collects target metrics from the retailer backend, and applies algorithms for ad offers; sends targets in segment for review by the campaign manager; and receives ad creatives and dynamically creates ads and associated backend server URL links.

What is claimed is:

1. A method for performing an enriched advertisement-based single-step electronic transaction, the method comprising:
at a backend server:
receiving an indication that a user is interested in a product in an advertisement that was presented to the user;
generating transaction information, the transaction information including product information, payment instrument information, and shipping information, and presenting it to the user in a manner such that the user need only perform a single step in order to trigger the transaction;
detecting that the user has performed the single step;
initiating the transaction; and
notifying the user of the result of the transaction.

2. The method of claim 1, wherein:
initiating the transaction comprises sending the transaction and payment information directly or indirectly to relevant parties for payment processing and fulfilment of the ecommerce transaction; and
presenting the transaction information to the user comprises generating and presenting to the user a landing page that includes the transaction information along with a button or image which the user can click or touch to initiate the transaction.

3. (canceled)

4. The method of claim 1, further comprising, prior to generating the transaction information:
determining that the user is a returning, untrusted user;
in response to determining that the user is a returning, untrusted user:
requesting the user to authenticate with the payment provider; and
receiving an indication of the result.

5. The method of claim 4, wherein determining that the user is a returning, untrusted user comprises determining that the user identity is known but the user device is not associated with the user or determining that the user has engaged in potentially fraudulent activity.

6. The method of claim 5, wherein receiving an indication of the result comprises at least one of:
receiving an indication that the authentication was successful, wherein the backend server associates the device with the user, or
receiving an indication that the authentication was unsuccessful, wherein the backend server marks the user device as being compromised.

7. (canceled)

8. The method of claim 1, further comprising, prior to generating transaction information
determining that the user is a new user, in response to determining that the user is a new user:
requesting the user to sign in with a payment provider and accept a checking/billing agreement that allows the backend server and/or seller to make payments on behalf of the user via the user's payment provider account;
storing customer information for the user;
generating a cookie or other tracking information;
storing an association of the cookie and a device signature of the device used by the user; and
providing the cookie and/or java script to the landing page.

9. (canceled)

10. The method of claim 1, wherein the advertisement that was presented to the user was presented by an Advertising Partner that:
Detected an association between the user and a payment provider;
matched the user to an advertising campaign segment;
filtered the user based on past user behavior;
filtered the user based on a fraud score and/or user history of behaviors;
matched the product based on user interest history;
retrieved the ad creative that includes a backend server URL; and
placed the targeted ad into content being consumed by the user.

11. The method of claim 1, wherein initiating the purchase comprises:
executing fraud business rules locally or at an entity different from the backend server;
determining fraud score based on behavior, history, velocity, and/or device signature;
upon a determination that fraud is likely, declining the purchase; and
upon a determination that fraud is not likely, initiating a transaction with the payment provider.

12. The method of claim 11, wherein initiating the transaction with the payment provider comprises:
retrieving payment information from the payment provider;
placing the order;
reporting the order status to the user; and
displaying a receipt to the user.

13. The method of claim 12, wherein retrieving payment information from the payment provider comprises:
requesting a Tokenized Primary Account Number, TPAN, from the payment provider, the request identifying the checkout/billing agreement and a transaction total; and
receiving the TPAN representing the card account number, Card Verification Value, CVV, or Card Verification Code, CVC, and expiration date, which are used when placing the order.

14. The method of claim 11, wherein initiating the transaction with the payment provider comprises:
providing transaction information to a payment provider to process payment transaction; and
receiving transaction result information from the payment provider.

15. The method of claim 14, wherein providing transaction information comprises providing an amount, a customer ID, and/or a seller ID.

16. The method of claim 14, wherein receiving transaction result information comprises receiving a transaction ID, an authorization ID, a transaction amount, and/or a retailer ID.

17. The method of claim 1, further comprising:
at the backend server:
detecting an update trigger event; and
in response to detecting the update trigger event, performing at least one of:
requesting a list of products from a retailer backend and updating product and pricing information maintained by the backend server;
requesting a list of offers from the retailer backend and updating offer information maintained by the backend server; and
requesting a list of available inventory form the retailer backend and updating inventory information maintained by the backend server.

18. The method of claim 17, wherein detecting an update trigger event comprises detecting creation of a new ad campaign, and/or detecting a change in products, offers, or inventory status.

19. The method of claim 1, further comprising:
requesting a payment provider to provide a list of user IDs for ad targeting; and
registering for push notification from the payment provider.

20. The method of claim 1, further comprising:
receiving, during an ad campaign wherein an advertising partner is serving ads through ad servers, feedback or detects changing conditions, and in response:
requesting a product inventory update;
targeting updates based on behavior, fraud or other condition or trend;
receiving verification that ads are being served to targeted users/devices; and/or
sending ad offers and creative updates to the ad partner.

21. The method of claim 1, further comprising:
receiving, from a campaign manager, a request to get products from a catalogue, retrieving current inventory from a retailer backend, and applying inventory rules for algorithms;
receiving ad offers and applying algorithms for the ad offers;
receiving a request to run algorithms for targets for ad offers, collecting target metrics from the retailer backend, and applying (1520) algorithms for ad offers;
sending targets in segment for review by the campaign manager; and/or
receiving ad creatives and dynamically creating ads and associated backend server URL links.

22. The method of 21 claim 1, wherein transaction information is displayed within a generic web browser or other standard, non-custom/non-customer-specific application, and clicking on the advertisement causes the landing page to be displayed by a backend server, without requiring or engaging a customer application.

23. A system for performing an enriched advertisement-based single-step electronic transaction, the system comprising a backend server, the backend server comprising:
one or more processors; and
memory storing instructions executable by the one or more processors, whereby the backend server is operable to:
receive an indication that a user is interested in a product in an advertisement that was presented to the user;
generate transaction information, the transaction information including product information, payment instrument information, and shipping information, and present it to the user in a manner such that the user need only perform a single step in order to trigger the transaction;
detect that the user has performed the single step;
initiate the transaction; and
notify the user of the result of the transaction.

24. (canceled)
